(19) United States
(12) Patent Application Publication
(10) Pub. No.: US 2025/0386061 A1
(43) Pub. Date: Dec. 18, 2025

(54) SERVER, TERMINAL AND COMPUTER PROGRAM

(71) Applicant: 17LIVE Japan INC., Tokyo (JP)

(72) Inventors: Wei-Hsiang HUNG, Taipei City (TW); Chu-Chuan LIN, Taipei City (TW)

(21) Appl. No.: 19/234,994

(22) Filed: Jun. 11, 2025

(30) Foreign Application Priority Data
Jun. 13, 2024 (JP) 2024-096103
Jun. 27, 2024 (JP) 2024-104331

(51) Int. Cl. H04N 21/2187; H04N 21/4784

(52) U.S. Cl. CPC H04N 21/2187; H04N 21/4784

(57) ABSTRACT

A server comprising a circuitry, wherein the circuitry is configured to perform: receiving a request on providing information about an event from a user terminal of a user; identifying a specific user according to the request; retrieving a leaderboard information corresponding to the specific user in the event; and providing the leaderboard information to the user terminal of the user. According to the present disclosure, it may simplify the process of requesting information about the event and encourage the interaction between livestreamers and viewers. Moreover, it may motivate the viewers to support their favorite livestreamer in the event. Therefore, the user experience may be enhanced and the quality of the live streaming service may be improved.

### CROSS-REFERENCE TO RELATED APPLICATIONS

This application is based on and claims the benefit of priority from Japanese Patent Application Serial No. 2024-096103 (filed on Jun. 13, 2024) and No. 2024-104331 (filed on Jun. 27, 2024), the contents of which are hereby incorporated by reference in their entirety.

### BACKGROUND OF THE DISCLOSURE

### Technical Field

This disclosure relates to information and communication technology, and in particular, to a server, terminal and computer program in a live streaming.

### Description of Related Art

Some APPs or platforms provide live streaming service for livestreamers and viewers to interact with each other. The livestreamers may have a performance to cheer up the viewer and the viewer may send gifts to support the livestreamers.

The APPs or platform providers always hold events to motivate the interaction between livestreamers and viewers. The livestreamers may select an event and start broadcasting. In order to win the events and receive reward, the livestreamers may do their best to cheer up the viewer. Patent Document 1 disclose a scenario that the livestreamer is participating in an event and the leaderboard may be displayed on screen.

However, if there is no support from the viewers or no reward for the livestreamers, it may discourage them from engaging in the event. Therefore, it is crucial to motivate the livestreamers to participate in the event and the viewers to support them.

The live streaming platform provides a live streaming selection page for the viewers to select. The viewers may get access to the streamers they are interested in via clicking a thumbnail to enter the live streaming room. Non-Patent Document 1 disclose an exemplary screenshot to indicate a live streaming selection page.

However, the information provided by the thumbnail is limited, so the viewers may not understand the contents of the live streaming room in an accurate and clear manner. Therefore, how to improve the display of the live streaming room in a more efficient and effective way is a very important issue.
[Patent Document 1]: JP7284908B
[Non-Patent Document 1]: https://17mediahelp.zendesk.com/hc/en-us/articles/31062631004697-%E7%9B%B4%E6%92%AD%E9%A0%81%E9%9D%A2

### SUMMARY OF THE INVENTION

An embodiment of subject application relates to a server comprising a circuitry, wherein the circuitry is configured to perform: receiving a request on providing information about an event from a user terminal of a user; identifying a specific user according to the request; retrieving a leaderboard information corresponding to the specific user in the event; and providing the leaderboard information to the user terminal of the user.

Another embodiment of subject application relates to a terminal comprising a circuitry, wherein the circuitry is configured to perform: receiving an UI object from a live streaming room of a specific user; displaying the UI object on a screen of the terminal; receiving a leaderboard information corresponding to the specific user in the event; and displaying the leaderboard information on the screen of the terminal; wherein the UI object is an event icon, gifting object or event sticker in a live streaming room.

Another embodiment of subject application relates to a computer program for causing a server to realize the functions of: receiving a request on providing information about an event from a user terminal of a user; identifying a specific user according to the request; retrieving a leaderboard information corresponding to the specific user in the event; and providing the leaderboard information to the user terminal of the user.

According to the present disclosure, it may simplify the process of requesting information about the event and encourage the interaction between livestreamers and viewers. Moreover, it may motivate the viewers to support their favorite livestreamer in the event. Therefore, the user experience may be enhanced and the quality of the live streaming service may be improved.

An embodiment of subject application relates to a server comprising a circuitry, wherein the circuitry is configured to perform: receiving a first thumbnail from a first user terminal of a first user and a second thumbnail from a second user terminal of a second user in response to a request of interaction from the first user or the second user; retrieving context data according to a setting of the interaction; rendering the first thumbnail and/or the second thumbnail on the context data to generate a thumbnail of the interaction; and replacing the generated thumbnail with the first thumbnail and/or the second thumbnail.

Another embodiment of subject application relates to a method, comprising: receiving a first thumbnail from a first user terminal of a first user and a second thumbnail from a second user terminal of a second user in response to a request of interaction from the first user or the second user; retrieving context data according to a setting of the interaction; rendering the first thumbnail and/or the second thumbnail on the context data to generate a thumbnail of the interaction; and replacing the generated thumbnail with the first thumbnail and/or the second thumbnail.

Another embodiment of subject application relates to a computer program for causing a server to realize the functions of: receiving a first thumbnail from a first user terminal of a first user and a second thumbnail from a second user terminal of a second user in response to a request of interaction from the first user or the second user; retrieving context data according to a setting of the interaction; rendering the first thumbnail and/or the second thumbnail on the context data to generate a thumbnail of the interaction; and replacing the generated thumbnail with the first thumbnail and/or the second thumbnail.

According to the present disclosure, information of the live streaming room may be received from the thumbnail of the live streaming room. Moreover, information between or among the related live streaming rooms may also be recognized from the combination of the thumbnails of the live streaming rooms. Therefore, the user experience may be improved.

### BRIEF DESCRIPTION OF THE DRAWINGS

FIG. 1 is a schematic configuration of a live streaming system 1 according to some embodiments of subject application;

FIG. 2 is a schematic block diagram of the user terminal 20 according to some embodiments of subject application;

FIG. 3 is a schematic block diagram of the server 10 according to some embodiments of subject application;

FIG. 4 shows an exemplary data structure of the stream DB 320 of FIG. 3;

FIG. 5 shows an exemplary data structure of the user DB 322 of FIG. 3;

FIG. 6 shows an exemplary data structure of the gift DB 324 of FIG. 3;

FIG. 7 shows an exemplary data structure of the event DB 326 of FIG. 3;

FIG. 8 shows an exemplary data structure of the historical record DB 328 of FIG. 3;

FIG. 9-FIG. 14 are exemplary screen images of a live-streaming room screen 660 shown on the display of the livestreamer user terminal 20 or the viewer user terminal 30;

FIG. 15 is exemplary functional configuration of the live streaming system 1 according to some embodiments of subject application;

FIG. 16 is a flowchart showing steps of an application activation process on the user terminals 20 and 30;

FIG. 17 is a schematic block diagram of the user terminal 20 according to some embodiments of subject application;

FIG. 18 is a schematic block diagram of the server 10 according to some embodiments of subject application;

FIG. 19 shows an exemplary data structure of the stream DB 320 of FIG. 18;

FIG. 20 shows an exemplary data structure of the user DB 322 of FIG. 18;

FIG. 21 shows an exemplary data structure of the context DB 324 of FIG. 18;

FIG. 22-FIG. 25 are exemplary screen images of a live streaming room screen 600 shown on the display of the livestreamer user terminal 20 or the viewer user terminal 30;

FIG. 26 is an exemplary functional configuration of the live streaming system 1 according to some embodiments of subject application;

FIG. 27-FIG. 29 are exemplary screen images of a live streaming room screen 600 shown on the display of the livestreamer user terminal 20 or the viewer user terminal 30;

FIG. 30 is an exemplary functional configuration of the live streaming system 1 according to some embodiments of subject application;

FIG. 31 is a flowchart showing steps of an application activation process on the user terminals 20 and 30;

FIG. 32 is an exemplary hardware configuration of the information processing device according to some embodiments of subject application.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

The live streaming system 1 according to some embodiments of subject application provides enhancement among the users to communicate and interact smoothly. More specifically, it entertains the viewers and livestreamers in a technical way.

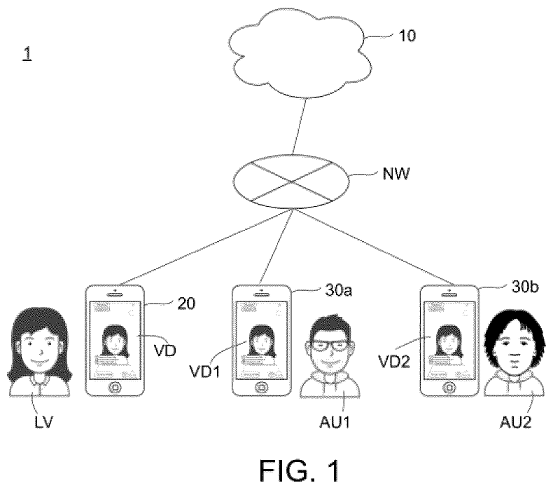

FIG. 1 shows a schematic configuration of a live streaming system 1 according to some embodiments of subject application. The live streaming system 1 provides a live streaming service for the streaming livestreamer (may also be referred as liver, streamer or distributor) LV and viewer (may also be referred as audience) AU (AU1, AU2 . . . ) to interact mutually in real time. As shown in FIG. 1, the live streaming system 1 may include a server 10, a user terminal 20 and a user terminal 30 (30a, 30b . . . ). The user terminal 20 may be a livestreamer and the user terminal 30 may be a viewer. In some embodiments, the livestreamers and viewers may be referred to as the user. The server 10 may include one or a plurality of information processing devices connected via network NW. The user terminal 20 and 30 may be, for example, a portable terminal such as the smartphone, tablet, laptop PC, recorder, mobile game console, wearable device or the like, or the stationary computer such as desktop PC. The server 10, user terminal 20 and user terminal 30 may be communicably connected by any type of wire or wireless network NW.

The live streaming system 1 is involved in the livestreamer LV, the viewer AU, and APP provider (not shown), who provides the server 10. The livestreamer LV may record his/her own contents such as songs, talks, performance, game streaming or the like by his/her own user terminal 20 and upload to the server 10 and be the one who distributes contents in real time. In some embodiments, the livestreamer LV may interact with the viewer AU via the live streaming.

The APP provider may provide a platform for the contents to go on live streaming in the server 10. In some embodiments, the APP provider may be the media or manager to manage the real time communication between the livestreamer LV and viewer AU. The viewer AU may access the platform by the user terminal 30 to select and watch the contents he/she would like to watch. The viewer AU may perform operations to interact with the livestreamer, such as commenting or cheering the livestreamer, by the user terminal 30. The livestreamer, who provides the contents, may respond to the comment or cheer. The response of the livestreamer may be transmitted to the viewer AU by video and/or audio or the like. Therefore, a mutual communication among the livestreamer and viewer may be accomplished.

The “live streaming” in this specification may be referred to as the data transmission which enables the contents the livestreamer LV recorded by the user terminal 20 to be substantially reproduced and watched by the viewer AU via the user terminal 30, In some embodiments, the “live streaming” may also refer to the streaming which is accomplished by the above data transmission. The live streaming may be accomplished by the well-known live streaming technology such as HTTP Live Streaming, Common Media Application Format, Web Real-Time Communications, Real-Time Messaging Protocol, MPEG DASH or the like. The live streaming may further include the embodiment that the viewer AU may reproduce or watch the contents with specific delay while the livestreamer is recording the contents. Regarding the magnitude of the delay, it should be at least small enough to enable the livestreamer LV and the viewer AU to communicate. However, live streaming is different from so-called on-demand streaming. More specifically, the on-demand streaming may be referred to as storing all data, which records the contents, in the server and then providing the data from the server to the user at random timing according to the user's request.

The “streaming data” in this specification may be referred to as the data includes image data or voice data. More specifically, the image data (may be referred to as video data) may be generated by the image pickup feature of the user terminal 20 and 30. The voice data (may be referred to as audio data) may be generated by the audio input feature of the user terminal 20 and 30. The streaming data may be reproduced by the user terminal 20 30, so that the contents relating to users may be available for watching. In some embodiments, during the period from the streaming data being generated by the user terminal 20 of the livestreamer to being reproduced by the user terminal 30 of the viewer, the processing of changing format, size or specification of the data, such as compression, extension, encoding, decoding, transcoding or the like, is predictable. Before and after this kind of processing, the contents (such as video and audio) are substantially unchanged, so it is described in the current embodiments of the present disclosure that the streaming data before being processed is the same as that after being processed. In other words, if the streaming data is generated by the user terminal 20 of the livestreamer and reproduced by the user terminal 30 of the viewer via the server 10, the streaming data generated by the user terminal 20 of the livestreamer, the streaming data passed through the server 10 and the streaming data received and reproduced by the by the user terminal 30 of the viewer are all the same streaming data.

As shown in FIG. 1, the livestreamer LV is providing the live streaming. The user terminal 20 of the livestreamer generates the streaming data by recording his/her video and/or audio, and transmits to the server 10 via the network NW. At the same time, the user terminal 20 may display the video VD on the display of the user terminal 20 to check the streaming contents of the livestreamer LV.

The viewer AU1, AU2 of the user terminal 30a, 30b, who request the platform to provide the live streaming of the livestreamer, may receive streaming data corresponding to the live streaming via the network NW and reproduce the received streaming data to display the video VD1, VD2 on the display and output the audio from a speaker or the like. The video VD1, VD2 displayed on the user terminal 30a, 30b respectively may be substantially the same as the video VD recorded by the user terminal 20 of the livestreamer LV, and the audio outputted from the terminal 30a, 30b may also be substantially the same as the audio recorded by the user terminal 20 of the livestreamer LV.

The recording at the user terminal 20 of the livestreamer may be simultaneous with the reproducing of the streaming data at the user terminal 30a, 30b of the viewer AU1, AU2. If a viewer AU1 inputs a comment on the contents of the livestreamer LV into the user terminal 30a, the server 10 will display the comment on the user terminal 20 of the livestreamer in real time, and also display on the user terminal 30a, 30b of the viewer AU1, AU2 respectively. If the livestreamer LV responds to the comment, the response may be outputted as the text, image, video or audio from the terminal 30a, 30b of the viewer AU1, AU2, so that the communication of the livestreamer LV and viewer LV may be realized. Therefore, the live streaming system may realize the live streaming of two-way communication.

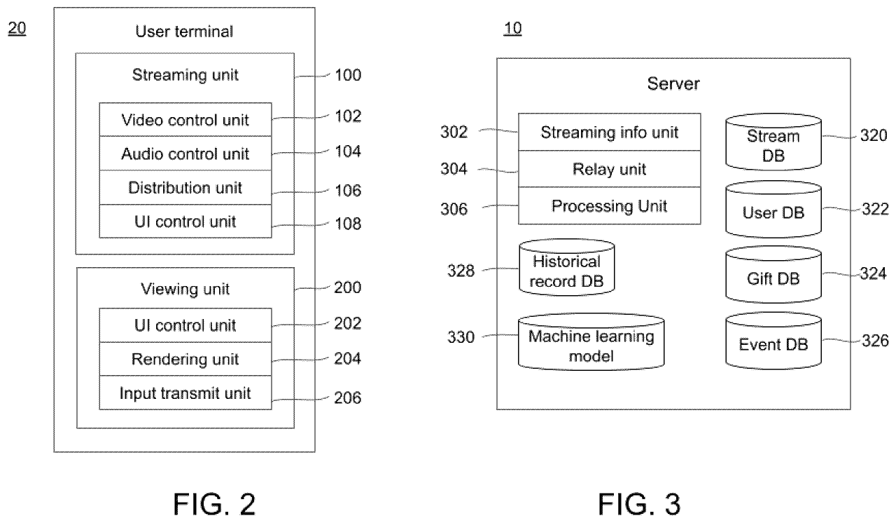

FIG. 2 is a block diagram showing a function and configuration of the user terminal 20 in FIG. 1 according to the embodiment of the present disclosure. The user terminal 30 has the similar function and configuration of the user terminal 20. The blocks depicted in the block diagram of this specification are implemented in hardware such as devices like a CPU of a computer or mechanical components, and in software such as a computer program depicts functional blocks implemented by the cooperation of these elements. Therefore, it will be understood by those skilled in the art that the functional blocks may be implemented in a variety of manners by a combination of hardware and software.

The livestreamer LV and viewer AU may download and install the live streaming application (live streaming APP) of the present disclosure to the user terminal 20 and 30 from the download site via network NW. Or the live streaming APP may be pre-installed in the user terminal 20 and 30. By the execution of the live streaming by the user terminal 20 and 30, the user terminals 20 and 30 may communicate with the server 10 via the network NW to realize a plurality of functions. The functions realized by the execution of the live streaming APP by the user terminal 20 and 30 (More specifically, the processor such as CPU) is described below as the functions of the user terminal 20 and 30. These functions are basically the functions that the live streaming APP makes the user terminals 20 and 30 realize. In some embodiments, these functions may also be realized by transmitting from the server 10 to the web browser of the user terminal 20 and 30 via network NW and be executed by the computer program of the web browser. The computer program may be written in the programming language such as HTML (Hyper Text Markup Language) or the like.

The user terminal 20 includes streaming unit 100 and viewing unit 200. In some embodiments, the streaming unit 100 is configured to record the audio and/or video data of the user and generate streaming data to transmit to the server 10. The viewing unit 200 is configured to receive and reproduce streaming data from server 10. In some embodiments, a user may activate the streaming unit 100 when broadcasting or activate the viewing unit 200 when watching streaming respectively. In some embodiments, the user terminal who is activating the streaming unit 100 may be referred to as a livestreamer or be referred to as the user terminal which generates the streaming data. The user terminal who is activating the viewing unit 200 may be referred to as a viewer or be referred to as the user terminal which reproduces the streaming data.

The streaming unit 100 may include video control unit 102, audio control unit 104, distribution unit 106 and UI control unit 108. The video control unit 102 may be connected to a camera (not shown) and the video is controlled by the camera. The video control unit 102 may obtain the video data from the camera. The audio control unit 104 may be connected to a microphone (not shown) and the audio is controlled by the microphone. The audio control unit 104 may obtain the audio data from the microphone.

The distribution unit 106 receives streaming data, which includes video data from the video control unit 102 and audio data from the audio control unit 104, and transmits to the server 10 via network NW. In some embodiments, the distribution unit 106 transmits the streaming data in real-time. In other words, the generation of the streaming data from the video control unit 102 and audio control unit 104, and the distribution of the distribution unit 106 is performed simultaneously.

UI control unit 108 controls the UI for the livestreamer. The UI control unit 108 is connected to a display (not shown) and is configured to generate the streaming data to whom the distribution unit 106 transmits, reproduces and displays the streaming data on the display. The UI control unit 108 shows the object for operating or the object for instruction-receiving on the display and is configured to receive the tap input from the livestreamer.

The viewing unit 200 may include UI control unit 202, rendering unit 204 and input transmit unit 206. The viewing unit 200 is configured to receive streaming data from server 10 via network NW. The UI control unit 202 controls the UI for the viewer. The UI control unit 202 is connected to a display (not shown) and/or speaker (not shown) and is configured to display the video on the display and output the audio from the speaker by reproducing the streaming data. In some embodiments, Outputting the video on the display and audio from the speaker may be referred to as “reproducing the streaming data”. The UI control unit 202 may be connected to an input unit such as touch panel, keyboard or display or the like to obtain input from the users.

The rendering unit 204 may be configured to render the streaming data from the server 10 and the frame image. The frame image may include user interface objects for receiving input from the user, the comments inputted by the viewers and the data received from the server 10. The input transmit unit 206 is configured to receive the user input from the UI control unit 202 and transmit to the server 10 via the network NW.

In some embodiments, the user input may be clicking an object on the screen of the user terminal such as selecting a live stream, entering a comment, sending a gift, following or unfollowing a user, voting in an event, gaming or the like. For example, the input transmit unit 206 may generate gift information and transmit to server 10 via the internet NW if the user terminal of the viewer clicks a gift object on the screen in order to send a gift to the livestreamer.

In some embodiments, the user terminal 20 may include a terminal side gift DB (not shown). The terminal side gift DB is configured to store the gift information of the user terminal 20 or 30. The terminal side gift DB may include gift ID, icon ID, effect data ID and final update date. The gift ID may identify the gift. The Icon ID may be the icon data of the gift object. The effect data ID may identify the data realizing the effect corresponding to the gift. The final update date may identify the final update date of the gift.

In some embodiments, the viewer may download the gift in advance or download the gift when sending gifts. In some embodiments, gift information may be downloaded and stored in the terminal side gift DB in advance. In some embodiments, the terminal side gift DB may include the gift list corresponding to the gift list provided by the server 10. In some embodiments, the gift list in the terminal side gift DB may be synchronized with the server 10 periodically or by an operation from the user.

FIG. 3 is a schematic block diagram of the server 10 according to some embodiments of the subject application. The server 10 may include streaming info unit 302, relay unit 304, processing unit 306, stream DB 320, user DB 322, gift DB 324, event DB 326, historical record DB 328 and machine learning model 330.

The streaming info unit 302 receives the request of live streaming from the user terminal 20 of the livestreamer via the network NW. Once receiving the request, the streaming info unit 302 registers the information of the live streaming on the stream DB 320. In some embodiments, the information of the live streaming may be the stream ID of the live streaming and/or the livestreamer ID of the livestreamer corresponding to the live streaming.

Once receiving the request of providing the information of the live streaming from the viewing unit 200 of the user terminal 30 from the viewer via the network NW, the streaming info unit 302 refers to the stream DB 320 and generates a list of the available live streaming.

The streaming info unit 302 then transmits the list to the user terminal 30 via the network NW. The UI control unit 202 of the user terminal 30 generates a live streaming selection screen according to the list and displays the list on the display of the user terminal 30.

Once the input transmit unit 206 of the user terminal 30 receives the selection of the live streaming from the viewer on the live streaming selection screen, it generates the streaming request including the stream ID of the selected live streaming and transmits to the server 10 via the network. The streaming info unit 302 may start to provide the live streaming, which is specified by the stream ID in the streaming request, to the user terminal 30. The streaming info unit 302 may update the stream DB 320 to add the viewer's viewer ID of the user terminal 30 to the livestreamer ID of the stream ID.

The relay unit 304 may relay the transmission of the live streaming from the user terminal 20 of the livestreamer to the user terminal 30 of the viewer in the live streaming started by the streaming info unit 302. The relay unit 304 may receive the signal, which indicates the user input from the viewer, from the input transmit unit 206 while the streaming data is reproducing. The signal indicating the user input may be the object-designated signal which indicates the designation of the object shown on the display of the user terminal 30. The object-designated signal may include the viewer ID of the viewer, the livestreamer ID of the livestreamer, who delivers the live streaming the viewer is viewing, and object ID specified by the object. If the object is a gift or the like, the object ID may be the gift ID or the like. Similarly, the relay unit 304 may receive the signal indicating the user input of the livestreamer, for example the object-designated signal, from the streaming unit 100 of the user terminal 20 while the streaming data is reproducing.

The processing unit 306 is configured to process requests in response to operations from a user terminal of a user. For example, the user may click on an event button to make a request on the information about the event. In some embodiments, the event button may be, for example, an event icon in the livestreaming room or an event selection in the event list. Once the relay unit 304 receives the request, the processing unit 306 may refer to the event DB 326 and retrieve the event list, and the processing unit 306 and the relay unit 304 may further transmit the event list to the user terminal of the user.

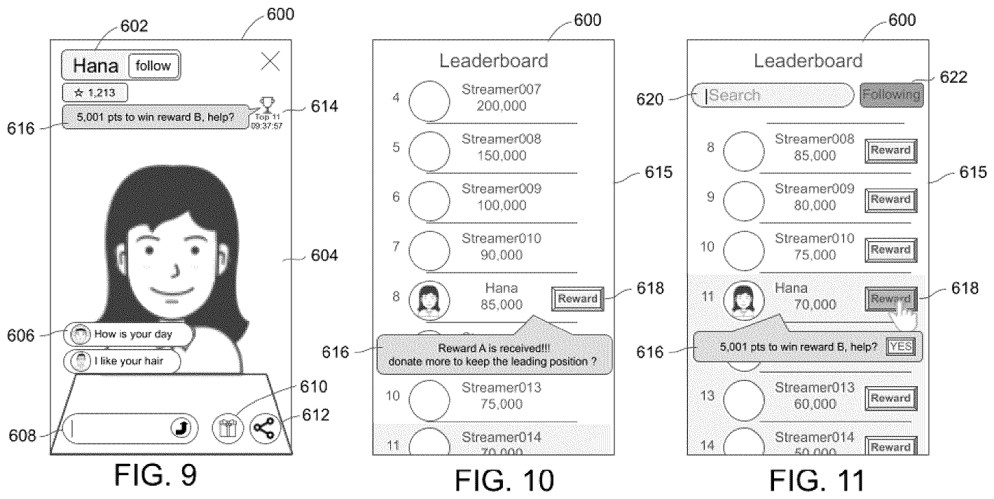

In some embodiments, a plurality of UI objects may be displayed in the live streaming room. Some of the UI objects may be generated by the livestreamers such as the sticker 650 and sticker 654 in FIG. 13 and FIG. 14. Some of the UI objects may be generated by Server 10 such as the gift object 610 and message 616 or the like in FIG. 9. Once the processing unit 306 receives the operation performed on the UI objects by the user of the user terminal, the processing unit 306 may proceed accordingly. For example, if the livestreamer generates an event sticker in the live streaming room, the relay unit 304 and processing unit 306 may transmit the event sticker to the viewers and then store information of the event sticker in the stream DB 320 or the like.

In some embodiments, the server 10 may further include gift info unit (not shown) and gift processing unit (not shown). The gift info unit provides information on gifts to the corresponding livestreamer and viewers. The gift info unit transmits, to the livestreamer, the gift information for the terminal in response to a request from the user terminals. The gift info unit obtains, from the gift DB 324, the effect data corresponding to the gift ID included in the gift information signal that has been received by the relay unit 304. The gift info unit transmits the obtained effect data to the other user terminals 20 and 30 as a response to the gift sending request signal.

The gift processing unit updates the user DB 322 so as to update the points of the livestreamer and the viewer depending on the points of the gift identified by the gift ID included in the gift usage signal. Specifically, the gift processing unit refers to the gift DB 324 to specify the points to be granted for the gift ID included in the received gift usage signal. The gift processing unit then updates the user DB 322 to add the determined points to the points of the livestreamer ID included in the gift usage signal. In some embodiments, the gift processing unit may also update the user DB 322 to subtract the determined points from the points of the viewer ID included in the gift usage signal.

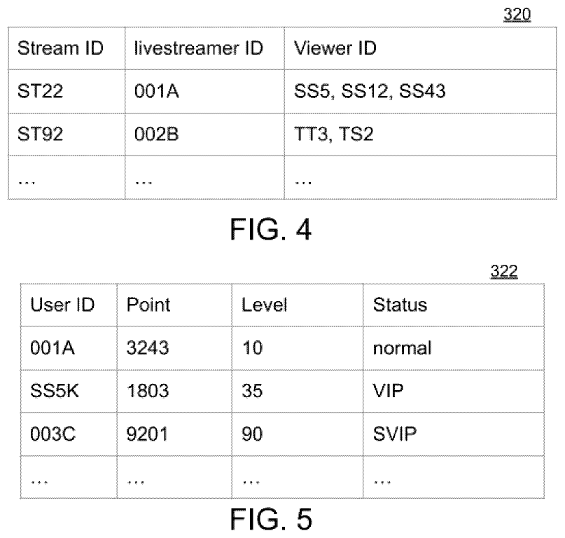

FIG. 4 shows an exemplary data structure of the stream DB 320 of FIG. 3. The stream DB 320 holds information regarding a live stream currently taking place. The stream DB 320 stores a stream ID for identifying a live-stream on a live distribution platform provided by the live-streaming system 1, a livestreamer ID for identifying the livestreamer who provides the live-stream, and a viewer ID for identifying a viewer of the live-stream, in association with each other.

FIG. 5 shows an exemplary data structure of the user DB 322 of FIG. 3. The user DB 322 holds information regarding users. The user DB 322 stores a user ID for identifying a user, points for identifying the points the user accumulates, level for identifying the level of the user and status for identifying the status of the user in association with each other. The point is the electronic value circulated within the live-streaming platform. The level may be an indicator of the amount of user activity or engagement on the live streaming platform. The status may be an identity or membership status of the user on the live streaming platform.

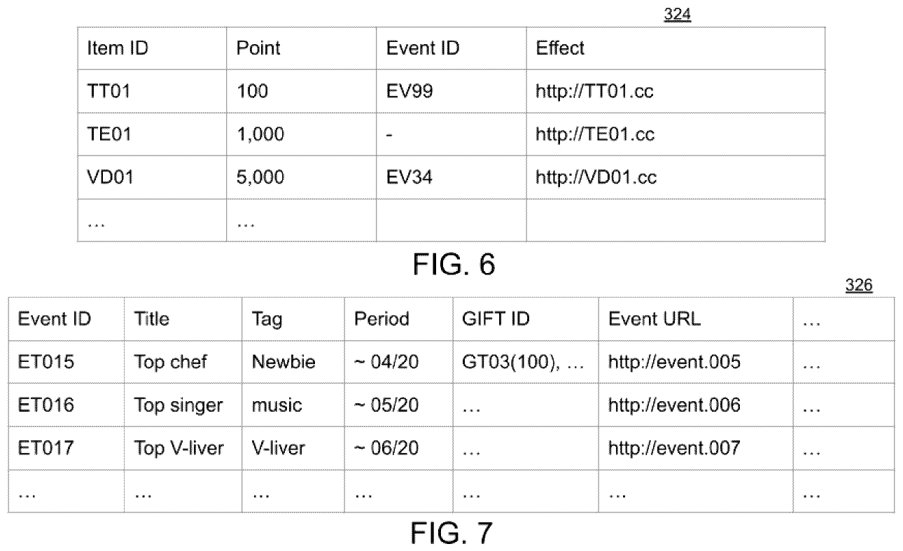

FIG. 6 shows an exemplary data structure of the gift DB 324 of FIG. 3. The gift DB 324 maintains information on gifts that can be used by the viewer in the live streaming. The gift DB 324 stores a gift ID for identifying a gift, the amount of points that the viewer spends in order to send the gift to the streamer, the event ID for identifying the event the gift is corresponding to, and the effect data for the gift, in association with each other.

The viewer can give the gift to the streamer by paying the equivalent value points for a desired gift while watching the live streaming. The payment of such equivalent value points can be made by an appropriate electronic means, for example, the viewer can pay the equivalent value points to the administrator. AIternatively, bank transfers or credit card payments can also be used. The relationship between awarded points and equivalent value points can be set arbitrarily by the administrator.

A gift is electronic data with the following characteristics:
It can be purchased in exchange for the points (later described in detail) or can be given for free.
It can be given by a viewer to a streamer.
Giving a gift to a streamer is referred to as using the gift or throwing the gift.
Some gifts may be purchased and used at the same time, and some gifts may be purchased or given and then used at any time later by the purchaser or recipient viewer.
When a viewer gives a gift to a streamer, the streamer is awarded the amount of points corresponding to the gift and an effect associated with the gift is exerted. For example, an effect corresponding to the gift will appear on the live streaming screen.

The effect is a visual or auditory or tactile effect (e.g., vibration) or a combination thereof that characterizes a gift. Examples of the visual effect include animation, images, and flashing/blinking. Examples of the auditory effect include sound effects and voice. The effect data is data for realizing such an effect on the user terminal 20, and the user terminal 20 realizes such an effect by processing the effect data. Since the technique for realizing the effect data itself is known, it will not be hereunder described in detail.

FIG. 7 shows an exemplary data structure of the event DB 326 of FIG. 3. The event DB 326 holds information regarding events on a live distribution platform provided by the live-streaming system 1. The event DB 326 stores an event ID for identifying an event, title for identifying title of the event, tag for identifying category or topic of the events, the period for identifying the starting time and end time of the event, the gift ID for identifying the gift in an event, the event URL for identifying the location of the event page, in association with each other.

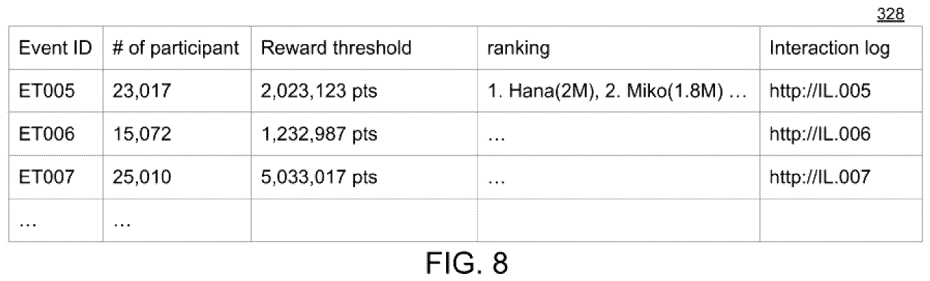

In some embodiments, the event DB 326 may store the information of events which are currently ongoing or expired. In some embodiments, a separated database may be provided for storing the historical event data. FIG. 8 shows an exemplary data structure of the historical record DB 328 of FIG. 3. The historical record DB 328 holds information regarding historical event data on a live distribution platform provided by the live-streaming system 1.

The historical record DB 328 stores an event ID for identifying an historical event, number of participant for identifying the number of participant in the event, reward threshold for identifying the threshold for receiving the reward, ranking for identifying the ranking of participant in the event, interaction log for identifying the interaction between livestreamers and viewers in the event, in association with each other. In some embodiments, the expired event may be moved to the historical record DB 328 for analysis, so the historical record DB 328 may also include the same information stored in the event DB 326.

Here, the “reward threshold” may refer to the condition to obtain reward in an event. For example, the event rules may state that if the livestreamer accumulates more than 1M points, they will obtain virtual items. Here, the 1M points may be referred to as the reward threshold. The event may also state that if the livestreamer is ranked at top 10 in the leaderboard, they will obtain the chance to perform or exposure to media. If the receiving points of the livestreamer at 10th place is 0.5M points, then the 0.5M points may be referred to as the reward threshold.

Here, the “interaction log” may be the data log in the live streaming platform during the period of the event. In some embodiments, the data log may include the operation from the user, the time information, the location information or other related information. For example, the data log may include that the livestreamer sang a song at a specific time point, the viewer donated five gifts with 2,000 points for each gift or the like. In some embodiments, the interaction log may also be arranged as a table or visualized as a chart for analysis.

In some embodiments, the machine learning models 330 may be any possible machine learning models such as the content-based mode, behavior-based model, language model such as ChatGPT or the like. In some embodiments, the machine language models may infer the possible output according to the input and the procedure of digesting may refer to providing users with the inference from the models.

FIG. 9-FIG. 14 are exemplary screen images of a live-streaming room screen 600 shown on the display of the livestreamer user terminal 20 or the viewer user terminal 30. Once the viewer selects and enters a live-streaming room, a live streaming room screen 600 of the livestreamer may be shown on the display. The live streaming room screen 600 may include a livestreamer info object 602, livestreamer image zone 604, message zone 606, message input box 608, gift object 610, sharing object 612 or the like.

The livestreamer info object 602 shows the information of the streamer. The livestreamer image zone 604 shows the image or video of the streamer and the image may be obtained by reproducing the video data. The message zone 606 shows the messages from the viewer, streamer or the server 10. The message input box 608 shows an input zone for the streamer or viewers to enter a message or the like. The gift object 610 provides the users with the function of gifting to the livestreamer and the sharing object 612 provides the users with the function of sharing the live streaming room. In some embodiments, the UI and the related function in the live streaming room may be designed flexibly.

In some embodiments, the live streaming room screen 600 may include an event icon 614 as shown in FIG. 9. The event icon 614 may show the event the livestreamer is currently participating in and also the remaining time of the event, the current rank or the like. In some embodiments, the livestreamer and viewers may click the event icon 614 to receive event description and current ranking. In some embodiments, once the event icon 614 is clicked, the corresponding event gift in the event may be displayed. For example, if the viewers click the event icon 614, the event gift tab in the gift list may be popped up for the viewers to send event gifts to support the livestreamer in an easier way.

In some embodiments, once the viewers enter the live streaming room, a message 616 shown in FIG. 9 may be displayed. The message 616 may include information to help the livestreamer win the event or the reward in the event or the like. More specifically, the message 616 may include information about the necessary condition for the livestreamer to receive a certain reward. For example, if the event distributes a reward B to the top 10 livestreamers and the livestreamer needs 5,001 points to be in the top 10, the message 616 may show the information of “5,001 points to win reward B” or the like.

In some embodiments, the message 616 may include the information about guiding the viewer to help the livestreamer achieve the condition. For example, if the livestreamer needs 10 gifts to achieve the condition, the message 616 may include the gift object 610, event gift list or one-key-to-help button to facilitate the process of helping the livestreamer. Here, the “one-key-to-help” button may refer to an UI button on the screen 600 for the viewer to click to help the livestreamer achieve the condition. It may be the signal from the user terminal 20, 30 to Server 10 to indicate the willingness to help the livestreamer. For example, if the view clicks the “one-key-to-help” button, Server 10 may select the necessary 10 gifts and the corresponding points from the viewer to the livestreamer to help the livestreamer achieve the condition. According to the embodiments, it may motivate the viewer to support the livestreamer and the process may also be facilitated in an efficient manner.

In some embodiments, all the necessary conditions including finished, in process or unfinished conditions may be displayed in the message 616. In some embodiments, only the unfinished conditions or the conditions in process may be displayed. In some embodiments, the conditions may also be displayed in a visualized manner. For example, the conditions may be displayed in a format of percentage, progress bar or the like.

In some embodiments, the message 616 may be displayed once the viewer enters the live streaming room. In some embodiments, the message 616 may be displayed once the viewer or the livestreamer move their finger or cursor near or on the event icon 614 or click the event icon 614 or the like. In some embodiments, the message 616 may also be triggered to be displayed by the viewers or livestreamers via message, voice or the like. For example, the viewer may comment “show the message” or the livestreamer may say “show the message” to trigger the display of the message. In some embodiments, the design and mechanism of the message 616 may be determined flexibly.

In some embodiments, the viewers and livestreamers may check the leaderboard to understand the current status of the event. In some embodiments, the leaderboard may be accessed via a general event list page. In some embodiments, once the leaderboard is accessed, the leaderboard may be displayed on top of the leaderboard, which means from the very beginning of the leaderboard. In some embodiments, the display of the leaderboard may also be focusing on a specific user, for example, jumping to the portion of a specific livestreamer. For example, if the viewer gets accessed to the leaderboard via a specific livestreamer's live streaming room, the leaderboard may be jumped to the portion of the livestreamer's rank.

In some embodiments, if the livestreamers or viewers would like to check their rank in a leaderboard, Server 10 may identify their user ID and then jump the leaderboard to the corresponding portion when they get accessed to the leaderboard. In some embodiments, if the user searches for a specific participant in a leaderboard, the leaderboard may also be jumped to the corresponding portion automatically or the like. In some embodiments, Server 10 may also memorize the habit, frequency or record of the user on checking or searching the leaderboard to provide the user with suggestions or the like.

In some embodiments, the leaderboard 615 may be displayed focusing on a specific livestreamer as shown in FIG. 10. As shown in FIG. 10, the portion of the leaderboard may be displayed focusing on the livestreamer Hana. In some embodiments, rank of the focused livestreamer may be displayed in an appropriate position such as centered, at the top, at the bottom or the like. In some embodiments, Server 10 may identify the livestreamer the user is going to check flexibly according to the identification of the user, the access to the leaderboard, the search conducted by the user or the like.

Once the specific livestreamer is identified, the message 616 may be displayed or popped up on the screen 600. In some embodiments, the leaderboard 615 may include UI objects to indicate threshold or condition for receiving the reward in the event. For example, the bright and dark background in FIG. 10 may indicate the threshold to receive reward from the event is top 10 or the like.

In some embodiments, the message 616 may also include the information about the reward the livestreamer is receiving currently. For example, if a reward A is distributed to the livestreamer with the receiving point over 80,000 and the livestreamer Hana achieved the condition, then an information of “Reward A is received!!!” may also be included in the message 616 for reference.

In some embodiments, the message 616 may include information about guiding the viewers to donate more to help the livestreamer keep the leading position. As shown in FIG. 10, the message 616 includes “donate more to keep the leading position?” to recommend the viewer donating more to prevent the livestreamer being out of the threshold or condition.

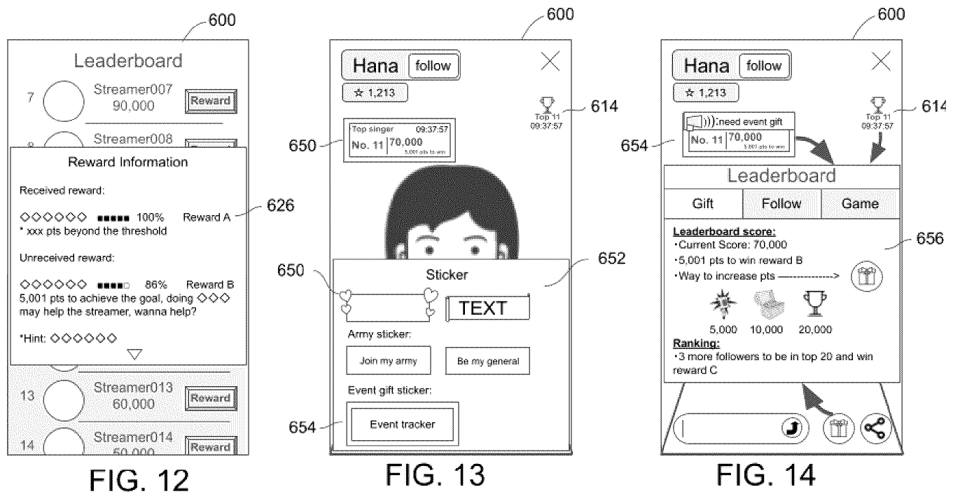

In some embodiments, if the livestreamer the user is going to check is identified, an UI button 618 may also be displayed adjacent to the livestreamer as shown in FIG. 10. In some embodiments, the UI button 618 may be displayed only on the specific user, or on all the user in the leaderboard. The viewer may get access to more information via the UI button 618 or the like. In some embodiments, the message 616 may be accessed via the UI button 618. In some embodiments, more information on the reward may be provided via clicking the UI button 618, and the information may be, for example, like the information 626 shown in FIG. 12. The information 626 will be described in detail later.

In some embodiments, if the livestreamer is not in the threshold or condition for receiving a reward, some UI object may be displayed on the screen 600 for reference. For example, the background of the livestreamer in a leaderboard may be different such as in white or gray color as shown in FIG. 10 or FIG. 11. In some embodiments, the message 616 may be displayed adjacent to the livestreamer to indicate the condition to achieve the threshold and the corresponding reward. According to the embodiments, it may be more understandable and motivate the viewer to help the livestreamer.

In some embodiments, the UI button 618 may also be displayed adjacent to each livestreamer in the leaderboard as shown in FIG. 11. The viewers may not only check the focused livestreamer, but also monitor the other livestreamers such as the previous or next livestreamer in the leaderboard. In some embodiments, the UI button 618 may be displayed adjacent to all livestreamers or specific livestreamers such as the previous three or next three livestreamer around the focused livestreamer. In some embodiments, a search tool 620 may be provided for the viewers to search for the livestreamers in the leaderboard. In some embodiments, a following button 622 may be provided for the viewers to click to show the livestreamer they are following or the like. In some embodiments, the display of the UI button 618 may be determined flexibly.

In some embodiments, viewers may receive more information on the reward via clicking the UI button 618. In some embodiments, the information may be like the information 626 shown in FIG. 12. As shown in FIG. 12, the information 626 may include the received reward, unreceived reward of the livestreamer, hints to guide the viewer to help the livestreamer or the like. In some embodiments, the condition for achieving the threshold and receiving the reward may be displayed in a visualized manner such as the percentage or progress bar displayed in FIG. 12. For example, if the livestreamer needs to receive 100 followers and currently there are only 86 followers, the percentage of the condition may be displayed like 86% or the like. According to the embodiments, it may help the viewer understand the current status easily.

In some embodiments, a plurality of UI objects may also be provided in the live streaming room. The UI objects may be generated by Server 10, the livestreamers, the viewers or the like. In some embodiments, the UI object provides the streamer with the function of generating an object such as the sticker 650 in FIG. 13 or the like on the screen 600. In some embodiments, the streamer may click a sticker object icon to get access to the sticker page 652, and all available stickers 650 may be displayed on the sticker page 652 for the streamer to select and generate.

In some embodiments, the stickers 650 may include a plurality of frames and functions for the streamer to select. The streamer may select a suitable frame and then edit text in the frame. In some embodiments, the stickers 650 may include a default sticker or a customized sticker. In some embodiments, the stickers 650 may also include the stickers with function of tracking the current event the livestreamer is participating in.

As shown in FIG. 13 and FIG. 14, an sticker 650 and event sticker 654 may also be provided on the screen 600 for the livestreamer to display the current status of the event. The event sticker 654 may include information such as the name of the event, the remaining time of the event, the current ranking, the current points or the like. In some embodiments, the event sticker 654 may also include the difference of the points of the livestreamer with the previous or the next livestreamer in the leaderboard. For example, if the livestreamer is at rank 11, and the difference of the points with livestreamers at rank 12 or rank 10 may be displayed for the livestreamer and viewers to understand the current status in the leaderboard.

In some embodiments, the event sticker 654 may include any possible and helpful information for the livestreamer and viewers to understand the current situation of the event. In some embodiments, the event sticker 654 may include information of a plurality of leaderboards. As shown in FIG. 14, the leaderboard information page 656 may display the current leaderboards the livestreamer or the viewers are participating in or involved in.

A variety of events may be held in a live streaming platform, and the condition to win an event may also be designed flexibly. For example, the receiving point, number of followers or the broadcasting duration of the livestreamers may be competed in an event. The leaderboard information page 656 may include the list of leaderboards the livestreamer is participating in or involved in. Moreover, page 656 may also include the current status, such as the current point of the livestreamer in the event. In some embodiments, the page 656 may include information about the necessary condition to win a certain reward. For example, the message may show that the livestreamer could receive reward B if 5,001 points were received or the like.

In some embodiments, the page 656 may also provide hints or solutions for helping the livestreamer with receiving the reward. For example, if the livestreamer needs 5,001 points to win reward B, an UI object such as the gift object 610 or the list of event gifts may be displayed in page 656 as shown in FIG. 14. In some embodiments, the page 656 may also include the information of the reward the livestreamer received at the current rank. In some embodiments, the information in page 656 may be determined flexibly according to the practical need.

In some embodiments, information of page 656 may be displayed in the event sticker 654 flexibly. For example, a UI link to page 656 may be provided in the event sticker 654. The event sticker 654 may also be expanded or collapsed to display or hide the information of page 656. The information of page 656 may also be displayed like a marquee in the event sticker 654. In some embodiments, information of page 656 may also be accessed via the event sticker 654, event icon 614, gift object 610 or the like. In some embodiments, the display and accessibility of page 656 may be determined flexibly.

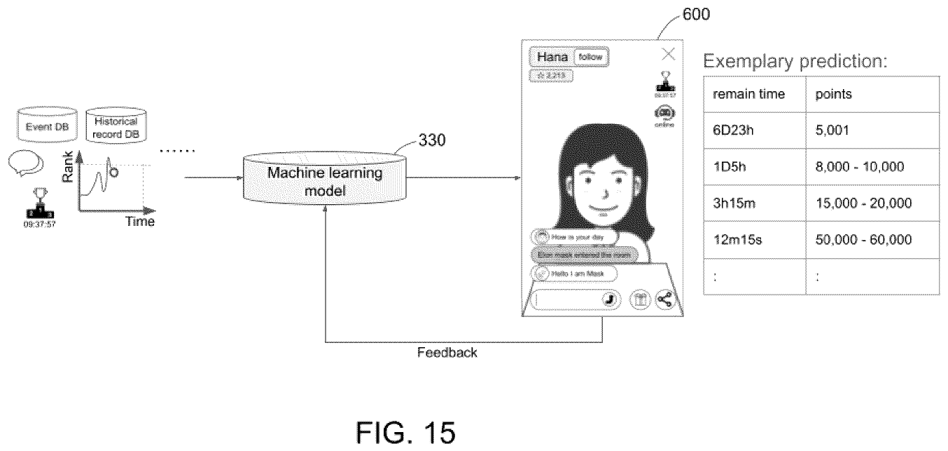

FIG. 15 is exemplary functional configuration of the live streaming system 1 according to some embodiments of subject application. As stated above, the APP provider may provide a plurality of events for the livestreamer to select and participate in to increase the interaction between livestreamers and viewers. In some embodiments, the livestreamer may participate in an event and start broadcasting. The processing unit 306 may retrieve real-time event data or historical event data from databases and feed them into a machine learning model such as machine learning model 330 to generate information on guiding the livestreamer in the event.

In some embodiments, the processing unit 306 may infer or predict a safety point for the viewers to donate before the end of an event. Here, the “safety point” may refer to a specific amount or a range of points for the livestreamer to achieve a threshold or condition to win a reward in an event. The safety point may be determined flexibly according to a plurality of parameters such as the timing of the event, historical data, real-time data in the live streaming room or the like. In some embodiments, the historical data may be, for example, the event data in the past, the event data similar to the current event or the like. In some embodiments, the real-time data may be, for example, the ranking information, interaction log such as messages, detailed description of the current or the like.

In some embodiments, the processing unit 306 may feed the above information into a machine learning model such as the machine learning model 330 and generate real-time hint information for the livestreamer and viewers as shown in FIG. 15. In some embodiments, the hint information may be, for example, the message 616, 626 or 656 described above, or information helpful to help the livestreamer with the event.

In some embodiments, the format of hint information may be any possible object that could guide the livestreamer to understand the event and increase the possibility of winning or achieve the threshold in the event. In some embodiments, the hint information may be text, image, video, AI assistance or the like. In some embodiments, the hint information for the livestreamers or viewers may further include the remaining time of the event, current ranking, the points behind the other users, or the donation combination of the livestreamer or the like.

In some embodiments, the processing unit 306 may monitor the situation of the live streaming room. For example, the processing unit 306 may monitor the status of receiving points or rank with respect to the time during the period of the event. The status may include, for example, the rank of the livestreamer with respect to the time, the reward threshold, the end time of the event or the like. The processing unit 306 may monitor the status and feedback back to the machine learning model 330. The machine learning model 330 may further generate hint information according to the feedback to help the livestreamer achieve the reward threshold or the like.

In some embodiments, the processing unit 306 feeds the above information into the machine learning model 330 to infer or predict a safety point with respect to the timing of the event in real-time. The table at the right side in FIG. 15 shows an exemplary prediction between the remaining time of the event and the recommended safety point. In some embodiments, the leaderboard in an event changes a lot, for example, one hour right before the end of the event or the like. Most of the viewers always sneak in and donate a lot of points right before the end of the event to help livestreamer to win the event. Therefore, it is crucial to donate a safety point to keep the livestreamer in a leading position.

In some embodiments, the safety point may be a specific amount of points. For example, the safety point may be 5,001 if the livestreamer needs 5,001 points to be ranked in top 10 and receive the reward. In some embodiments, the safety point may be a range of points predicted via machine learning model or the like. For example, the machine learning model may output an appropriate range of safety points according to historical data or real-time data in the live streaming room. In some embodiments, the closer to the end of the event, the higher the recommended safety point would be. The recommended safety point may be inferred via the machine learning model and according to the above information such as historical event record, current ranking information or the like. According to the embodiments, the viewer may help the livestreamer win the event in an efficient and effective manner.

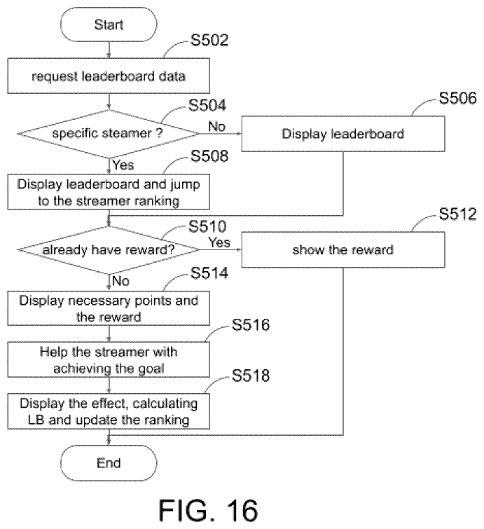

The operation of the live streaming system 1 with the above configuration will be now described. FIG. 16 is a flowchart showing steps of an application activation process on the user terminals 20 and 30. Once a user enters a live streaming room, the user may perform an operation by the user terminal to interact with a livestreamer. In some embodiments, the operation may include commenting, sending gifts, following, unfollowing, voting, gaming or the like.

In some embodiments, the viewers or the livestreamer may request the leaderboard data via their user terminal to check the current status of the ranking in the event (S502). In some embodiments, if the request is from a general access without any user specified (No in S504), the leaderboard may be displayed, for example, on top of the leaderboard (S506), which indicates that a full leaderboard is requested to be accessed and checked. In some embodiments, if a specific user is identified in the request (Yes in S504), the leaderboard may be jumped to the rank of the specific livestreamer and displayed focusing on the portion of the livestreamer (S508). For example, if the viewers get access to the leaderboard via a specific livestreamer's live streaming room, the livestreamer may be identified as the specific livestreamer.

Furthermore, the reward information may be displayed on the screen 600 for the reference. In some embodiments, if the livestreamer is currently receiving some rewards (Yes in S510), information of the reward may be displayed on the screen 600 (S512). In some embodiments, if no reward is received or the livestreamer is close to receiving some rewards (No in S510), information of the reward and/or the necessary points to achieve the threshold may be displayed on the screen 600 (S514).

In some embodiments, the information may further include information about guiding or helping the viewers achieve the goal (S516). For example, the information may include a one-key-to-help button, gift object 610 icon, event gift list stated above or the other possible information. In some embodiments, once the viewers select one method to help the livestreamer, the corresponding process such as displaying the gift effect, calculating the leaderboard and updating the ranking in the event may be realized accordingly.

According to the embodiments, it may simplify the process of requesting information about the event and encourage the interaction between livestreamers and viewers. Moreover, it may motivate the viewers to support their favorite livestreamer in the event. Therefore, the user experience may be enhanced and the quality of the live streaming service may be improved.

In some embodiments, the users may transmit a request on providing information about an event to Server 10. In some embodiments, the request may be transmitted, for example, while the user enters a live streaming room, checks an event or checks a leaderboard in the event or the like. For example, if the livestreamer is participating in an event and a viewer enters the live streaming room, the viewer may request the information of the event via the user terminal. The information may be rendered and displayed on the screen 600 as the event icon 614 in FIG. 9. In some embodiments, the viewers may check the leaderboard of the event the livestreamer is participating in, the viewers may request information of the ranking in a leaderboard of the event via the user terminal as shown in FIG. 10 or FIG. 11.

In some embodiments, a specific user may be identified from the request. The specific user may be the user himself or herself, a specific livestreamer or the like. For example, if the viewer accesses a leaderboard via a livestreamer's live streaming room or conducts a search on a livestreamer's ranking in the leaderboard, the livestreamer may be identified as the specific user. If the user is a livestreamer participating in an event and is checking the leaderboard, the livestreamer himself or herself may be identified as the specific user.

In some embodiments, once the specific user is identified, Server 10 may retrieve the information about an event. The information may be leaderboard information such as the event description, ranking, threshold or condition for winning the reward or the like. In some embodiments, Server 10 may further provide the information to the livestreamer or the viewer. According to the embodiments, it may simplify the process of requesting information about the event, and encourage the interaction between livestreamers and viewers.

In some embodiments, the present disclosure may include the following embodiments:
1. A server comprising a circuitry, wherein the circuitry is configured to perform: receiving a request on providing information about an event from a user terminal of a user; identifying a specific user according to the request; retrieving a leaderboard information corresponding to the specific user in the event; and providing the leaderboard information to the user terminal of the user.
2. The server according to embodiment 1, wherein: the leaderboard information includes a threshold or condition to receive a reward in the event, and the corresponding reward; and the leaderboard information is displayed in response to the user of the user terminal entering a live streaming room or checking a leaderboard from the leaderboard information.
3. The server according to embodiment 1, further including: providing details of the leaderboard information in response to an operation from the user terminal of the user; wherein the details of the leaderboard information include a threshold or condition to receive a reward in the event, and the corresponding reward.
4. The server according to embodiment 1, further including: generating safety points via machine learning models; and displaying the safety points and the corresponding reward; wherein the safety points are predicted points to receive a reward in the event by the end of the event according to historical or real-time event data.
5. The server according to embodiment 1, further including: An UI object is provided with respect to the specific user in a leaderboard; and the UI object is configured to provide the user of the user terminal with details of the leaderboard information; and the details of the leaderboard information include a threshold or condition to receive a reward in the event, and the corresponding reward.
6. A terminal including a circuitry, wherein the circuitry is configured to perform: receiving an UI object from a live streaming room of a specific user; displaying the UI object on a screen of the terminal; receiving a leaderboard information corresponding to the specific user in the event; and displaying the leaderboard information on the screen of the terminal; wherein the UI object is an event icon, gifting object or event sticker in a live streaming room.
7. The terminal according to embodiment 6, wherein: the leaderboard information includes a threshold or condition to receive a reward in the event, and the corresponding reward; and the leaderboard information is displayed in response to the user of the user terminal entering a live streaming room or checking a leaderboard from the leaderboard information.
8. The server according to embodiment 6, further including: providing details of the leaderboard information in response to an operation from the user terminal of the user; wherein the details of the leaderboard information include a threshold or condition to receive a reward in the event, and the corresponding reward.
9. The terminal according to embodiment 6, wherein: the UI object further includes the name of an event, remaining time of the event, current ranking or current points of the specific user, or the difference of the points of the specific user with the previous or the next user in the leaderboard.
10. A computer program for causing a server to realize the functions of: receiving a request on providing information about an event from a user terminal of a user; identifying a specific user according to the request; retrieving a leaderboard information corresponding to the specific user in the event; and providing the leaderboard information to the user terminal of the user.

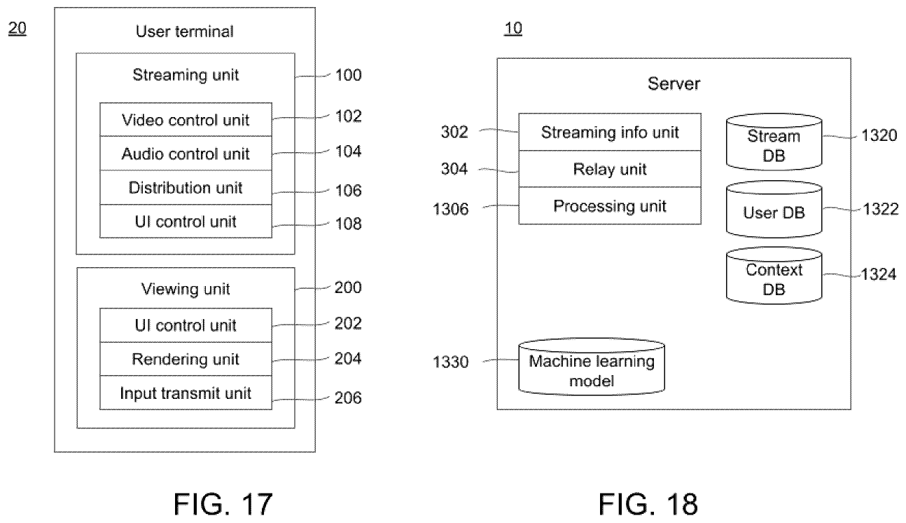

FIG. 17 is a block diagram showing a function and configuration of the user terminal 20 in FIG. 1 according to the embodiment of the present disclosure. The user terminal 20 in FIG. 17 is the same as the user terminal 20 in FIG. 2; therefore, the explanation of FIG. 17 is omitted. For a description of the user terminal 20 in FIG. 17, please refer to FIG. 2.

FIG. 18 is a schematic block diagram of the server 10 according to some embodiments of the subject application. The server 10 may include streaming info unit 302, relay unit 304, processing unit 1306, stream DB 1320, user DB 1322, context DB 1324 and machine learning model 1330.

The streaming info unit 302 receives the request of live streaming from the user terminal 20 of the livestreamer via the network NW. Once receiving the request, the streaming info unit 302 registers the information of the live streaming on the stream DB 1320. In some embodiments, the information of the live streaming may be the stream ID of the live streaming and/or the livestreamer ID of the livestreamer corresponding to the live streaming.

Once receiving the request of providing the information of the live streaming from the viewing unit 200 of the user terminal 30 from the viewer via the network NW, the streaming info unit 302 refers to the stream DB 1320 and generates a list of the available live streaming.

The streaming info unit 302 then transmits the list to the user terminal 30 via the network NW. The UI control unit 202 of the user terminal 30 generates a live streaming selection screen according to the list and displays the list on the display of the user terminal 30.

Once the input transmit unit 206 of the user terminal 30 receives the selection of the live streaming from the viewer on the live streaming selection screen, it generates the streaming request including the stream ID of the selected live streaming and transmits to the server 10 via the network. The streaming info unit 302 may start to provide the live streaming, which is specified by the stream ID in the streaming request, to the user terminal 30. The streaming info unit 302 may update the stream DB 1320 to add the viewer's viewer ID of the user terminal 30 to the livestreamer ID of the stream ID.

The relay unit 304 may relay the transmission of the live streaming from the user terminal 20 of the livestreamer to the user terminal 30 of the viewer in the live streaming started by the streaming info unit 302. The relay unit 304 may receive the signal, which indicates the user input from the viewer, from the input transmit unit 206 while the streaming data is reproducing. The signal indicating the user input may be the object-designated signal which indicates the designation of the object shown on the display of the user terminal 30. The object-designated signal may include the viewer ID of the viewer, the livestreamer ID of the livestreamer, who delivers the live streaming the viewer is viewing, and object ID specified by the object. If the object is a gift or the like, the object ID may be the gift ID or the like. Similarly, the relay unit 304 may receive the signal indicating the user input of the livestreamer, for example the object-designated signal, from the streaming unit 100 of the user terminal 20 while the streaming data is reproducing.

In some embodiments, the server 10 may further include gift info unit (not shown) and gift processing unit (not shown). The gift info unit provides information on gifts to the corresponding livestreamer and viewers. The gift info unit transmits, to the livestreamer, the gift information for the terminal in response to a request from the user terminals. The gift info unit obtains, from the gift DB 324 (not shown in FIG. 18, may refer to FIG. 3), the effect data corresponding to the gift ID included in the gift information signal that has been received by the relay unit 304. The gift info unit transmits the obtained effect data to the other user terminals 20 and 30 as a response to the gift sending request signal.

The gift processing unit updates the user DB 1322 so as to update the points of the livestreamer and the viewer depending on the points of the gift identified by the gift ID included in the gift usage signal. Specifically, the gift processing unit refers to the gift DB 324 to specify the points to be granted for the gift ID included in the received gift usage signal. The gift processing unit then updates the user DB 1322 to add the determined points to the points of the livestreamer ID included in the gift usage signal. In some embodiments, the gift processing unit may also update the user DB 1322 to subtract the determined points from the points of the viewer ID included in the gift usage signal.

The processing unit 1306 is configured to handle the generation of the multiple-user interaction. In some embodiments, the processing unit 1306 may receive a request of multiple-user interaction from a user terminal of a user. In some embodiments, the processing unit 1306 may transmit the request to another user terminal of another user. In some embodiments, the processing unit 1306 may transmit a rejection message to the user terminal of the user in response to a rejection of interaction from another user terminal of another user. Once another user accepts the interaction, the processing unit 1306 may transmit an acceptance message to the user terminal of the user and proceed with the establishment of the multiple-user interaction.

In some embodiments, the processing unit 1306 may handle the setting of the multiple-user interaction such as the generation of the thumbnail or the like. In some embodiments, once the livestreamer is going to broadcast, a thumbnail of the broadcasting may be determined. The thumbnail may be determined flexibly by, for example, being uploaded or selected by the livestreamer, by default setting from Server 10, or by AI generation or the like. Once the thumbnail is determined, the processing unit 1306 may update the thumbnail in stream DB 1320. Therefore, once the viewers request the live streaming selection list from Server 10, a plurality of live streaming with the thumbnails may be provided for the viewers to view.

In some embodiments, the processing unit 1306 may retrieve the streaming data from the livestreamer as a context data for generating thumbnails. The streaming data may be, for example, live streaming data, archive streaming data or any possible video or image data provided or generated by the livestreamer or Server 10 or the like. In some embodiments, the processing unit 1306 may retrieve the thumbnails of the livestreamers for generating a new thumbnail. The thumbnails may be, for example, from the above streaming data or any possible source or the like. In some embodiments, some image pre-processing, processing or post-processing of the streaming data may also be performed by the processing unit 1306 such as removing background, adjusting resolution, cutting or trimming to appropriate size or the like.

In some embodiments, the processing unit 1306 may render the streaming data on the context data to generate the thumbnail. An exemplary functional embodiment would be described in detail later. In some embodiments, the processing unit 1306 may determine the thumbnail for each livestreamer. Once the thumbnail for each livestreamer is determined, the processing unit 1306 may update the corresponding thumbnail to the corresponding livestreamer and update the stream DB 1320 accordingly or the like.

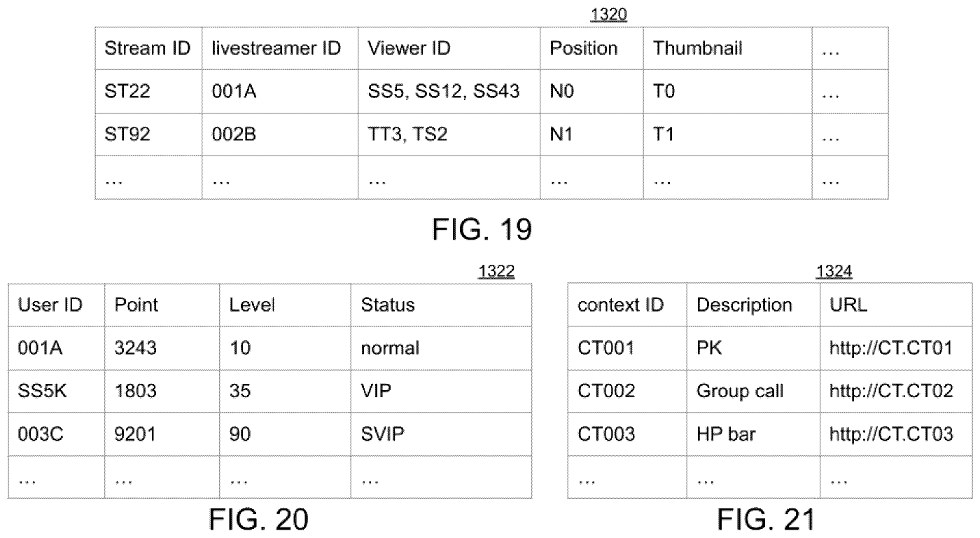

FIG. 19 shows an exemplary data structure of the stream DB 1320 of FIG. 18. The stream DB 1320 holds information regarding a live streaming currently taking place. The stream DB 1320 stores a stream ID for identifying a live streaming on a live distribution platform provided by the live streaming system 1, a livestreamer ID for identifying the livestreamer who provides the live stream, and a viewer ID for identifying a viewer of the live stream, in association with each other.

In some embodiments, the stream DB 1320 may store a position for identifying the position of the live streaming at the live streaming selection page and a thumbnail for identifying the thumbnail of the live streaming at the live streaming selection page, in association with each other. In some embodiments, the position may be a natural number indicating the order of the thumbnail at the live streaming selection page. In some embodiments, the thumbnail may be an URL or the like identifying the location of the thumbnail, and the thumbnail may be an image, video or the like determined by Server 10, uploaded by the users or the like.

FIG. 20 shows an exemplary data structure of the user DB 1322 of FIG. 18. The user DB 1322 holds information regarding users. The user DB 1322 stores a user ID for identifying a user, points for identifying the points the user accumulates, level for identifying the level of the user and status for identifying the status of the user in association with each other. The point is the electronic value circulated within the live streaming platform. The level may be an indicator of the amount of user activity or engagement on the live streaming platform. The status may be an identity or membership status of the user on the live streaming platform.

FIG. 21 shows an exemplary data structure of the context DB 1324 of FIG. 18. The context DB 1324 holds information regarding context data. The context DB 1324 stores a context ID for identifying a context data, a description for identifying the description of the context data, and a URL identifying the location of the context data, in association with each other. In some embodiments, the context may be text object, image object, video object or the like provided by the live streaming system 1 or uploaded by the user.

In some embodiments, the context data in the context DB 1324 may be the background materials or decoration materials for the thumbnail. In some embodiments, the context may be the image or video of the livestreamers, and the image or video may be retrieved from live streaming data, archived streaming data of the livestreamer or the like. In some embodiments, the context may also be some background image or video uploaded from the user, provided by the live streaming system 1 or retrieved from the internet or the like. In some embodiments, the context may also be determined flexibly according to the practical need.

In some embodiments, the machine learning models 1330 may be any possible machine learning models such as the content-based mode, behavior-based model, language model such as ChatGPT, image generation such as Midjourney or the like. In some embodiments, the machine language models may infer the possible output according to the input and the procedure of digesting may refer to providing users with the inference from the models. In some embodiments, the machine language models may generate an image or video according to the input from the live streaming room or the like.

In some embodiments, Server 10 in FIG. 18 may further include a gift DB (not shown) like the gift DB 324 in FIG. 3. In some embodiments, Server 10 may further include an event DB (not shown) like the event DB 326 in FIG. 3. For a description of the gift DB and event DB, please refer to the corresponding description of the gift DB 324 and event DB 326.

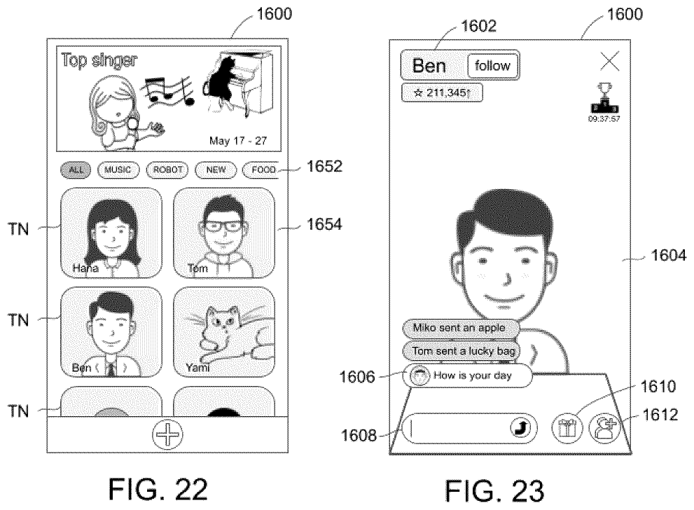

FIG. 22-FIG. 25 and FIG. 27-FIG. 29 are exemplary screen images of a screen 1600 shown on the display of the livestreamer user terminal 20 or the viewer user terminal 30. As shown in FIG. 22, the server 10 may provide a screen 1600 of the live streaming selection. The screen 1600 of live streaming selection may include tab object 1652 for the viewer to adjust the arrangement and layout of the stream. The screen 1600 of live streaming selection may also include the display zone 1654 to display the thumbnails TN of the live streaming for the viewer to select the streamer to watch.

In some embodiments, the livestreamer info object 1602 may include an “all” tab, “category” tab or the like for the viewer. The “all” tab may be used to display all streams and the “category” tab may be used to display streams classified by category. In some embodiments, the category of streams may include “latest”, “female”, “v-liver”, “singer” or the like, and the category may be added, removed, updated or modified by the server 10 flexibly according to practical need.

As shown in FIG. 23, once the viewer selects and enters a live streaming room, a screen 1600 of the live streaming room of the livestreamer may be shown on the display. The screen 1600 of live streaming room may include a livestreamer info object 1602, livestreamer image zone 1604, message zone 1606, message input box 1608, gift object 1610, sharing object (not shown) or the like. The livestreamer info object 1602 shows the information of the streamer. The livestreamer image zone 1604 shows the image or video of the streamer and the image may be obtained by reproducing the video data.

The message zone 1606 shows the messages from the viewer, streamer or the server 10. The message input box 1608 shows an input zone for the streamer or viewers to enter a message or the like. The gift object 1610 provides the users with the function of gifting to the livestreamer and the sharing object provides the users with the function of sharing the live streaming room. In some embodiments, the UI and the related function in the live streaming room may be designed flexibly.

In some embodiments, a UI button 1612 for the livestreamer to have multiple-user interaction may be provided. The livestreamer may click the button to invite viewers or the other livestreamers to co-broadcast in the live streaming room. The co-broadcast may be, for example, a PK, a group call or any possible scenarios for multiple-user interaction.

In some embodiments, the PK may refer to two or more livestreamer to compete during a specific duration. For example, the two livestreamer may compete for the receiving points from the viewers in five minutes. In some embodiments, the group call may refer to a plurality of users to have an interaction such as talk, chat or the like in the live streaming room. For example, four livestreamers may co-broadcast to talk about the latest news and share their thoughts on it or the like.

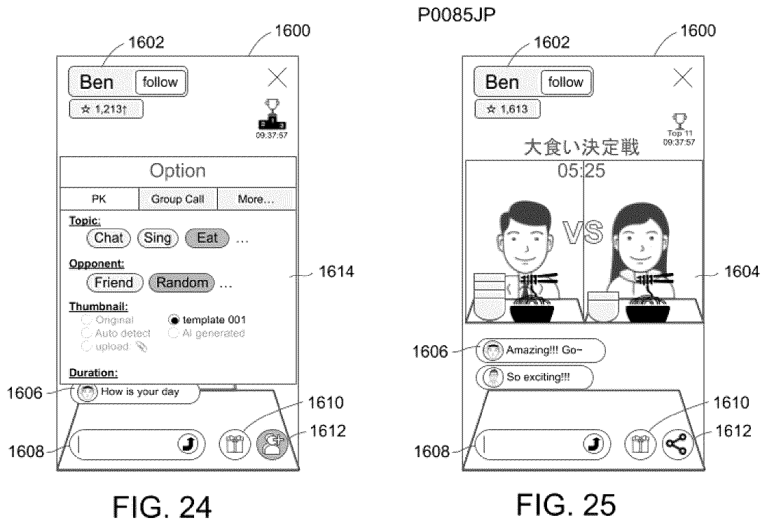

In some embodiments, access to the PK setting or group call setting may be from the same or separated UI button. In some embodiments, once a multiple-user interaction is selected, the corresponding setting page 1614 may be displayed on the screen 1600. FIG. 24 shows an example of PK setting. As shown in FIG. 24, the topic, opponent, thumbnail and duration or the like may be set in advance.

The topic may be the contents related to the PK such as a PK of talent or singing. The opponent is another livestreamers and may be selected by the livestreamer, recommended from Server 10 or randomly determined by Server 10 or the like. The duration is the time duration of the PK. In some embodiments, the duration may be three, five minutes or set by the livestreamer flexibly or the like.

The thumbnail may refer to an image or video display on the live streaming selection page for the viewers to view and select to enter the live streaming room. In some embodiments, the thumbnail may be a small-size image or the like. In some embodiments, the thumbnail may be set automatically from, for example, a clip of the livestreamer's streaming data or selected by the livestreamer himself or herself or the like.

In some embodiments, if one livestreamer invites another livestreamer to have a PK or the like, the thumbnails of each livestreamer may be their original thumbnails or replaced with another thumbnails. As shown in FIG. 24, the livestreamer may select to use the original thumbnail, a template thumbnail, an AI generated thumbnail or upload a brand-new thumbnail for the PK.

In some embodiments, the context DB 1324 may provide a plurality of context as the background of the new thumbnail for different scenarios. For example, the context may be an eating competition in a PK or a gossipy talk in a group call. The processing unit 1306 may retrieve the corresponding template from the context DB 1324. In some embodiments, the processing unit 1306 may also recommend the livestreamer with appropriate template according to, for example, the topic of the PK or the like. The recommendation may be realized by, for example, machine learning model or the like. Once the PK setting is finished, the livestreamer may start the PK with another livestreamer. Once the other accepts the PK, streaming data of the two livestreamers may be rendered and displayed in the same live streaming room as shown in FIG. 25. In some embodiments, the number of livestreamers may be two or more than two. In some embodiments, the scenario may not only be the PK but also the group call or the like.

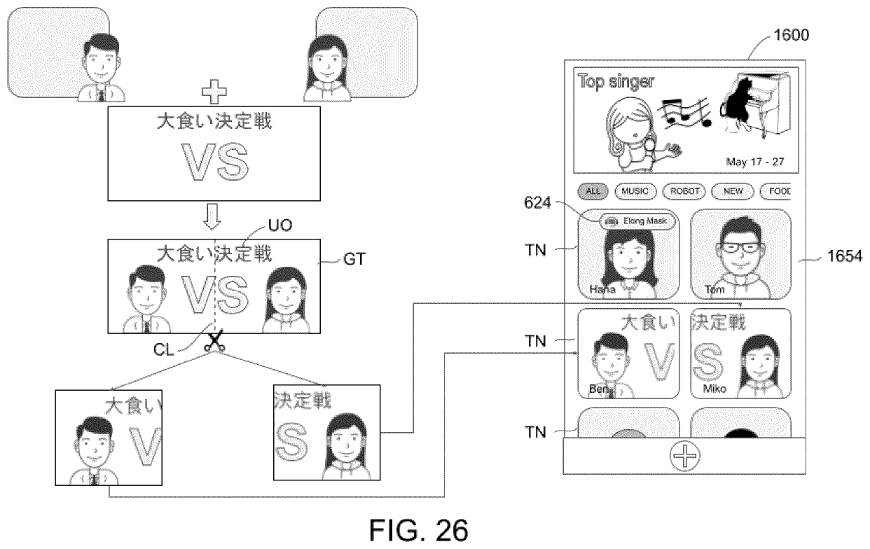

In some embodiments, once a livestreamer invites another livestreamer to have a PK or group call, the processing unit 1306 may determine the thumbnails of the two livestreamers. FIG. 26 is an exemplary functional configuration of the live streaming system 1 according to some embodiments of subject application. As shown in FIG. 26, the processing unit 1306 may retrieve the thumbnails of the two livestreamers separately. In some embodiments, the thumbnails may be the live streaming data, archived streaming data, the streaming data uploaded by the livestreamer or selected by Server 10 or the like. In some embodiments, the processing unit 1306 may extract the image of the two livestreamers from the streaming data. In some embodiments, the image may be a real or virtual image of the livestreamer or the like.

In some embodiments, the streaming data may include any possible image such as a landscape, a pet, an item or the like. The processing unit 1306 may retrieve a specific object to represent the livestreamer or the like. In some embodiments, the processing unit 1306 may retrieve other streaming data from the livestreamer such as the display image of the livestreamer in the profile page, the post from the livestreamer or the like. In some embodiments, the processing unit 1306 may perform some image pre-processing or post-processing such as removing the background or adjusting the resolution or the like. In some embodiments, the process of the streaming data may be determined flexibly according to the practical need.

In some embodiments, the processing unit 1306 may retrieve context data from Server 10 such as the context DB 1324. The context DB 1324 may include some template background for different topics or the like. In some embodiments, the context DB 1324 may include some UI objects for decorating the background of the thumbnail. For example, if the two livestreamers are in a game PK, the health point bar 1656 or fight icon 1658 shown in FIG. 29 may be provided to decorate the background of the thumbnails.

In some embodiments, the processing unit 1306 may render the streaming data from the livestreamers on the context data to generate the thumbnails of the livestreamers. In some embodiments, the processing unit 1306 may perform some other image processing to, for example, decorate the background according to the topic of the multiple-user interaction or according to the operations from the livestreamer or the like.

In some embodiments, the processing unit 1306 may generate one thumbnail for the two livestreamers. In some embodiments, the processing unit 1306 may generate two thumbnails for the two livestreamers respectively. In some embodiments, the processing unit 1306 may generate one thumbnail and cut it into several portions to be the thumbnail for each livestreamer. In some embodiments, some image pre-processing, processing or post-processing may be performed on the generated thumbnail flexibly.

In some embodiments, the thumbnail may be cut into pieces according to, for example, the number of livestreamers or the like. For example, if the multiple-user interaction is a eating competition between two livestreamers, the generated thumbnail may be 2×1 in size and cut into two portions for the two livestreamers as shown in FIG. 26. In some embodiments, once the thumbnails for each livestreamer is determined, the processing unit 1306 may distribute the corresponding thumbnail to the corresponding livestreamers.

In some embodiments, the generated thumbnail GT may be cut into a plurality of portions as shown in FIG. 26. In some embodiments, a cutting line CL of the generated thumbnail is on at least one of the plurality of UI objects UO as shown in FIG. 26. According to the embodiments, the portions of generated thumbnail displayed on the live streaming selection page may be combined as intact UI objects as shown in FIG. 26. It may provide the user a brand-new user experience and the viewers may receive information about the corresponding live streaming room from the thumbnail accordingly.

In some embodiments, the processing unit 1306 may further determine the position of the thumbnails at the live streaming selection page. For example, the two live streaming shared the corresponding thumbnails may be ordered adjacent to each other. If the thumbnail is arranged in two rows or in two columns, the two live streaming with the corresponding thumbnails may be ordered at the place of 2n+1 and n is natural numbers. In some embodiments, the thumbnails may also be arranged in more than two rows or more than two columns, and the arrangement of the corresponding thumbnails may also be arranged adjacent to each other accordingly.

In some embodiments, the position of the thumbnail of the live streaming at the live streaming selection page may be determined flexibly by, for example, the popularity, the number of viewers in the live streaming room. In some embodiments, once the livestreamers have a multiple-user interaction such as the PK or group call, their popularity may keep their original popularity or be the same as each other.

In some embodiments, their popularity for each live streaming room may be the average value of the total amount of their popularity. In some embodiments, their popularity may be a total of their respective popularity or the like. In some embodiments, once the live streaming room with corresponding thumbnails shares the same popularity, their order at the thumbnail page may be arranged adjacent to each other if the order is determined according to the popularity or the like.

In some embodiments, the processing unit 1306 may determine the order of the thumbnail at the thumbnail page flexibly. For example, the parameter of “position” may be provided by the stream DB 1320. The parameter of “position” may be, for example, a natural number to determine the order of the thumbnail at the live streaming list. The processing unit 1306 may modify, update or re-arrange the order of each live streaming room flexibly.

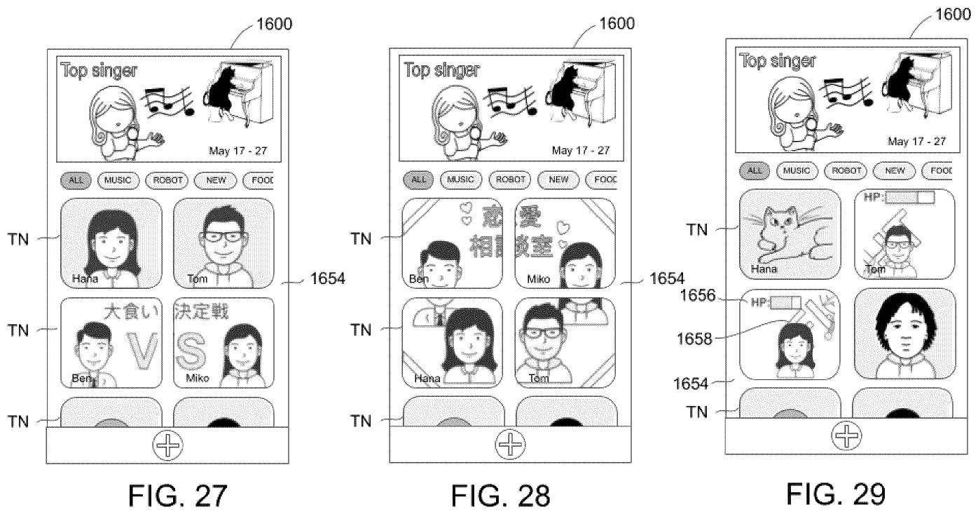

In some embodiments, the replaced thumbnail may provide the viewers with the information about the live streaming room. As shown in FIG. 27, the livestreamer Ben and Miko are in a PK now, and it may be told from the thumbnails because the thumbnail is generated from the process described above. The viewers may understand that the two livestreamers in the live streaming room are at a multiple-user interaction. According to the embodiments, information of the live streaming room and between or among different live streaming rooms may be understood easily and the user experience may be improved.

In some embodiments, there may be white gap or no white gap between the thumbnails. In some embodiments, the length or width of the gap between the thumbnails may be determined flexibly. In some embodiments, the gap between the corresponding thumbnails may be different from the other thumbnails at the live streaming list page. For example, the gap between the live streaming room at PK interaction may be no or smaller than others at the live streaming list page.

In some embodiments, all the thumbnails of the live streaming room may be arranged at a general page such as the “all” tab page. For example, the corresponding thumbnails may be arranged together with the other thumbnails at a general page. In some embodiments, a separated subgroup may be provided to accommodate the live streaming room with multiple-user interaction. For example, a multiple-user interaction tab or more specifically a “PK” or “group” tab may be provided to accommodate the thumbnail of the live streaming room having a multiple-user interaction such as PK or group call or the like.

As shown in FIG. 28, the livestreamers Ben, Miko, Hana and Tom are in a group call discussing relationships. In some embodiments, the thumbnail may include, for example, the member in the group call, the topic of the group call, some decorations such as ribbons, hearts or the like. According to the embodiments, viewers may easily understand that the four livestreamers are in a multiple-user interaction and the user experience may be improved.

As shown in FIG. 29, the livestreamers Tom and Miko are at a game interaction. The thumbnail may show that they are now having a game fight and their corresponding health point bar 1656 or the like. In some embodiments, the number of thumbnails may be two, three, four or more. In some embodiments, the arrangement of the corresponding thumbnail may be up and down, left and right, or upper right and down left as shown in FIG. 29 or the like. In some embodiments, the number, arrangement or the like of the thumbnail may be determined flexibly according to the practical need.

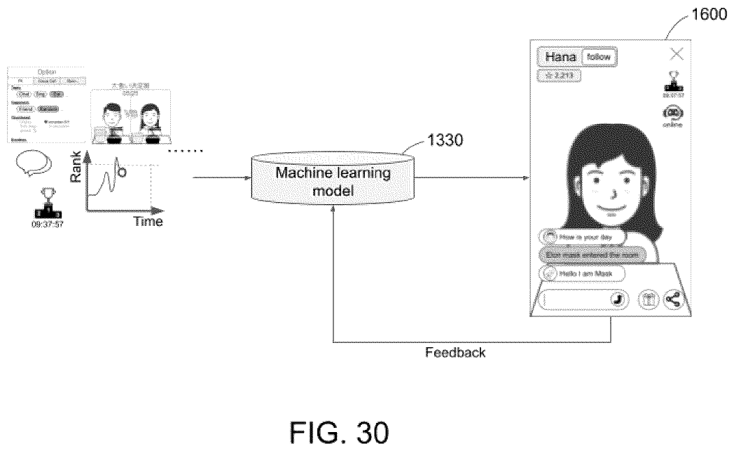

FIG. 30 is exemplary functional configuration of the live streaming system 1 according to some embodiments of subject application. As stated above, the Server 10 may generate thumbnails for the livestreamer during a multiple-user interaction. In some embodiments, the livestreamer may start broadcasting and participate in a multiple-user interaction. In some embodiments, the generation of the thumbnail may also be realized via a machine learning model such as the machine learning model 1330.

In some embodiments, the processing unit 1306 may retrieve the corresponding data and feed them into the machine learning model 1330 to generate thumbnails. In some embodiments, the corresponding information may be, for example, the setting of the multiple-user interaction, the current status in the live streaming room, the comments from the streamers or viewers, the on-going event, the receiving points of the streamer, the real-time or historical data in the live streaming room or the like. For example, the livestreamer may set a topic in the PK setting page, and the machine learning model 1330 may generate a thumbnail related to the topic accordingly.

In some embodiments, the processing unit 1306 may infer or predict a scenario in the live streaming room and generate thumbnails in real-time according to the scenario in the live streaming room. For example, a PK is ongoing in a live streaming room, and the PK may be divided into preparation period, PK period and penalty period or the like. Here, the “penalty period” may refer to the period after the PK and the one who loses the PK must do something as a penalty for the loss. In some embodiments, each period of the PK may have the corresponding thumbnails and the thumbnails may be generated via the above process or via the machine learning model 1330.

In some embodiments, the processing unit 1306 may monitor the situation of the live streaming room and feedback back to the machine learning model 1330. In some embodiments, the status in the live streaming room such as the conversation may be fed into the machine learning model 1330 to infer or predict the scenario, and further generate thumbnails accordingly. For example, a group call discussing relationships is ongoing. The processing unit 1306 may feed the discussion into the machine learning model 1330. Once the discussion is over and the co-broadcaster would like to talk about something else such as fortune-telling, the machine learning model 1330 may infer or predict a topic change in the live streaming room and re-generate the thumbnail accordingly.

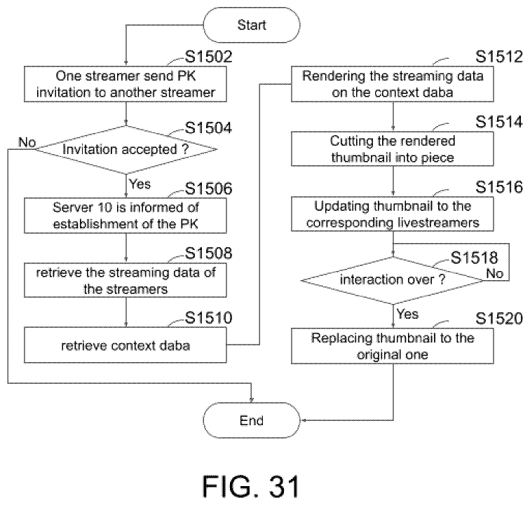

FIG. 31 is a flowchart showing steps of an application activation process on the user terminals 20 and 30. As shown in FIG. 31, a livestreamer may send a PK invitation to another livestreamer (S1502). Another livestreamer may ignore or reject the invitation from the livestreamer or the like (No in S1504). Once another livestreamer accepts the invitation (Yes in S1504), Server 10 may be informed of the establishment of the PK and the following process for arranging the PK may be performed accordingly (S1506).

In some embodiments, Server 10 may retrieve the streaming data, for example, the thumbnail of the two livestreamers from stream DB 1320 or the like (S1508). In some embodiments, Server 10 may retrieve the context data from, for example, the context DB 1324 or the like (S1510). In some embodiments, the context data may also be selected by Server 10 or provided by the livestreamer or the like.

Once the data for generating the thumbnail such as the streaming data and context data is retrieved, Server 10 may perform the corresponding process to generate the thumbnails for the live streaming room (S1512). For example, the streaming data of the livestreamers may be rendered on the template background to generate the new thumbnails for the livestreamer.

In some embodiments, the thumbnail may be cut into pieces according to the number of live streaming rooms or the like (S1514). In some embodiments, if multiple users have multiple-user interaction, their live streaming room may be merged into one live streaming room or kept the original number. In some embodiments, if the live streaming rooms is merged into one live streaming room, the generated thumbnail may be used as the thumbnail for the live streaming room.

In some embodiments, if the number of the live streaming room is kept as the original number of the live streaming room, the generated thumbnail may be used as the thumbnail for each live streaming room. In some embodiments, the thumbnail for each live streaming room may be a portion of the generated thumbnail or the like. In some embodiments, the determination and distribution of the thumbnail may be determined flexibly.

In some embodiments, once the thumbnail is generated and any possible image processing is done, the generated thumbnail may be updated to the corresponding livestreamers and the thumbnail in the stream DB 1320 may be updated accordingly (S1516). Once the update is done, the viewers who surf the live streaming selection list page may receive the latest thumbnails for each live streaming room and the viewers may easily understand the information between the corresponding live streaming room from the thumbnails.

In some embodiments, the multiple-user interaction such as the PK or group call may continue until the end of the interaction according to the setting (No in S1518). For example, if the interaction is a PK and the PK may be over after a specific period. If the interaction is a group call, the group call may be over after the conversation is finished and the livestreamer ends the group call. In some embodiments, if the PK is over or the livestreamers end the group call (Yes in S1518), the thumbnails for each livestreamer may be changed back to the original one (S1520). According to the embodiments, the thumbnail would be changed back to the original thumbnail, so that it would not cause any misunderstanding or the like.

According to the embodiments, information of the live streaming room may be received from the thumbnail of the live streaming room. Moreover, information between or among the related live streaming rooms may also be recognized from the combination of the thumbnails of the live streaming rooms. Therefore, the user experience may be improved.

In some embodiments, the present disclosure may include the following embodiments:
1. A server including a circuitry, wherein the circuitry is configured to perform: receiving a first thumbnail from a first user terminal of a first user and a second thumbnail from a second user terminal of a second user in response to a request of interaction from the first user or the second user; retrieving context data according to a setting of the interaction; rendering the first thumbnail and/or the second thumbnail on the context data to generate a thumbnail of the interaction; and replacing the generated thumbnail with the first thumbnail and/or the second thumbnail.
2. The server according to embodiment 1, further including: replacing the generated thumbnail with the first and/or second thumbnail in response to the interaction being over.
3. The server according to embodiment 1, further including: cutting the generated thumbnail into a plurality of portions according to the number of the users; replacing a first portion of the generated thumbnail with the first the thumbnail and a second portion of the generated thumbnail with the second thumbnail.
4. The server according to embodiment 1, further including: determining a position of the first thumbnail and second thumbnail at a live streaming selection page; wherein the position of the first thumbnail and second thumbnail is adjacent to each other.
5. The server according to embodiment 1, further including: the context data is a default template, materials provided by the users or generated by AI according to a topic of the interaction.
6. The server according to embodiment 1, further including: determining a gap between thumbnails at a live streaming selection page; wherein the gap between the first thumbnail and the second thumbnail is different from that between the other thumbnails.
7. The server according to embodiment 1, further including: rendering a plurality of UI objects on the generated thumbnail; and cutting the generated thumbnail into a plurality of portions: wherein a cutting line of the generated thumbnail is on at least one of the plurality of UI objects.
8. The server according to embodiment 1, further including: performing image processing on the first thumbnail and second thumbnail to extract a first icon and a second icon representing the first user and second user; wherein the first thumbnail and the second thumbnail are generated by default from streaming data of the first user or second user, uploaded by the first user or the second user or generated by AI.
9. A method, including: receiving a first thumbnail from a first user terminal of a first user and a second thumbnail from a second user terminal of a second user in response to a request of interaction from the first user or the second user; retrieving context data according to a setting of the interaction; rendering the first thumbnail and/or the second thumbnail on the context data to generate a thumbnail of the interaction; and replacing the generated thumbnail with the first thumbnail and/or the second thumbnail.
10. A computer program for causing a server to realize the functions of: receiving a first thumbnail from a first user terminal of a first user and a second thumbnail from a second user terminal of a second user in response to a request of interaction from the first user or the second user; retrieving context data according to a setting of the interaction; rendering the first thumbnail and/or the second thumbnail on the context data to generate a thumbnail of the interaction; and replacing the generated thumbnail with the first thumbnail and/or the second thumbnail.

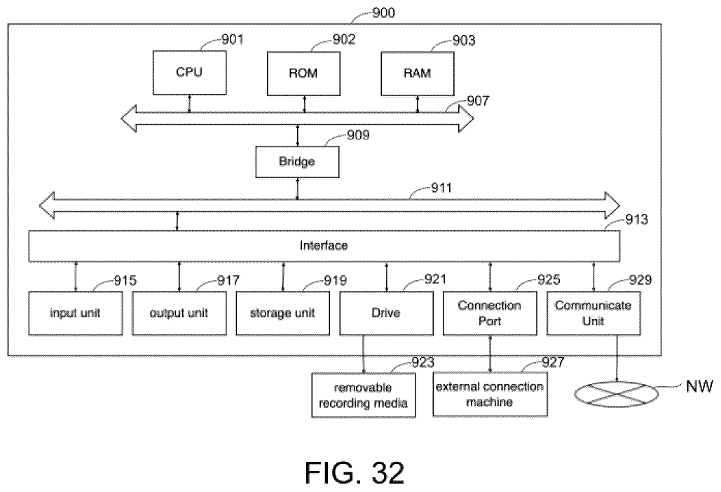

FIG. 32 is a schematic block diagram of computer hardware for carrying out a system configuration and processing according to some embodiments of subject application. The information processing device 900 in FIG. 32 is, for example, is configured to realize the server 10 and the user terminal 20, 30 respectively according to some embodiments of subject application.

The information processing device 900 includes a CPU 901, read only memory (ROM) 902, and random-access memory (RAM) 903. In addition, the information processing device 900 may include a host bus 907, a bridge 909, an external bus 911, an interface 913, an input unit 915, an output unit 917, a storage unit 919, a drive 921, a connection port 925, and a communication unit 929. The information processing device 900 may include imaging devices (not shown) such as cameras or the like. The CPU 901 is an example of hardware configuration to realize various functions performed by the components described herein. The functions described herein may be realized by circuitry programmed to realize such functions described herein. The circuitry programmed to realize such functions described herein includes a central processing unit (CPU), a digital signal processor (DSP), a general-use processor, a dedicated processor, an integrated circuit, application specific integrated circuits (ASICs) and/or combinations thereof. Various units described herein as being configured to realize specific functions, including but not limited to the streaming unit 100, the viewing unit 200, the video control unit 102, the audio control unit 104, the distribution unit 106, the UI control unit 108, the UI control unit 202, the rendering unit 204, the input transmit unit 206, the streaming info unit 302, the relay unit 304, the processing unit 306, the stream DB 320, the user DB 322, the gift DB 324, the event DB 326 and the historical record DB 328, the processing unit 1306, the stream DB 1320, the user DB 1322, the context DB 1324 and so on, may be embodied as circuitry programmed to realize such functions.

The CPU 901 functions as an arithmetic processing device and a control device, and controls the overall operation or a part of the operation of the information processing device 900 according to various programs recorded in the ROM 902, the RAM 903, the storage unit 919, or a removable recording medium 923. For example, the CPU 901 controls overall operations of respective function units included in the server 10 and the user terminal 20 and 30 of the above-described embodiment. The ROM 902 stores programs, operation parameters, and the like used by the CPU 901. The RAM 903 transiently stores programs used when the CPU 901 is executed, and parameters that change as appropriate when executing such programs. The CPU 901, the ROM 902, and the RAM 903 are connected with each other via the host bus 907 configured from an internal bus such as a CPU bus or the like. The host bus 907 is connected to the external bus 911 such as a Peripheral Component Interconnect/Interface (PCI) bus via the bridge 909.

The input unit 915 is a device operated by a user such as a mouse, a keyboard, a touchscreen, a button, a switch, and a lever. The input unit 915 may be a device that converts physical quantity to electrical signal such as audio sensor (such as microphone or the like), acceleration sensor, tilt sensor, infrared radiation sensor, depth sensor, temperature sensor, humidity sensor or the like. The input unit 915 may be a remote-control device that uses, for example, infrared radiation and another type of radio waves. AIternatively, the input unit 915 may be an external connection device 927 such as a mobile phone that corresponds to an operation of the information processing device 900. The input unit 915 includes an input control circuit that generates input signals on the basis of information which is input by a user to output the generated input signals to the CPU 901. The user inputs various types of data and indicates a processing operation to the information processing device 900 by operating the input unit 915.

The output unit 917 includes a device that can visually or audibly report acquired information to a user. The output unit 917 may be, for example, a display device such as an LCD, a PDP, and an OLED, an audio output device such as a speaker and a headphone, and a printer. The output unit 917 outputs a result obtained through a process performed by the information processing device 900, in the form of text or video such as an image, or sounds such as audio sounds.

The storage unit 919 is a device for data storage that is an example of a storage unit of the information processing device 900. The storage unit 919 includes, for example, a magnetic storage device such as a hard disk drive (HDD), a semiconductor storage device, an optical storage device, or a magneto-optical storage device. The storage unit 919 stores therein the programs and various data executed by the CPU 901, and various data acquired from an outside.

The drive 921 is a reader/writer for the removable recording medium 923 such as a magnetic disk, an optical disc, a magneto-optical disk, and a semiconductor memory, and built in or externally attached to the information processing device 900. The drive 921 reads out information recorded on the mounted removable recording medium 923, and outputs the information to the RAM 903. The drive 921 writes the record into the mounted removable recording medium 923.

The connection port 925 is a port used to directly connect devices to the information processing device 900. The connection port 925 may be a Universal Serial Bus (USB) port, an IEEE1394 port, or a Small Computer System Interface (SCSI) port, for example. The connection port 925 may also be an RS-232C port, an optical audio terminal, a High-Definition Multimedia Interface (HDMI (registered trademark)) port, and so on. The connection of the external connection device 927 to the connection port 925 makes it possible to exchange various kinds of data between the information processing device 900 and the external connection device 927.

The communication unit 929 is a communication interface including, for example, a communication device for connection to a communication network NW. The communication unit 929 may be, for example, a wired or wireless local area network (LAN), Bluetooth (registered trademark), or a communication card for a wireless USB (WUSB).

The communication unit 929 may also be, for example, a router for optical communication, a router for asymmetric digital subscriber line (ADSL), or a modem for various types of communication. For example, the communication unit 929 transmits and receives signals on the Internet or transmits signals to and receives signals from another communication device by using a predetermined protocol such as TCP/IP. The communication network NW to which the communication unit 929 connects is a network established through wired or wireless connection. The communication network NW is, for example, the Internet, a home LAN, infrared communication, radio wave communication, or satellite communication.

The imaging device (not shown) is a device that images real space using an imaging device such as a charge coupled device (CCD) or a complementary metal oxide semiconductor (CMOS), for example, and various members such as a lens for controlling image formation of a subject image on the imaging device and generates a captured image. The imaging device may capture a still picture or may capture a movie.

The present disclosure of the live streaming system 1 has been described with reference to embodiments. The above-described embodiments have been described merely for illustrative purposes. Rather, it can be readily conceived by those skilled in the art that various modifications may be made in making various combinations of the above-described components or processes of the embodiments, which are also encompassed in the technical scope of the present disclosure.

The procedures described herein, particularly flowchart or those described with a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present disclosure.

In some embodiments, at least a part of the functions performed by the server 10 may be performed by other than the server 10, for example, being performed by the user terminal 20 or 30. In some embodiments, at least a part of the functions performed by the user terminal 20 or 30 may be performed by other than the user terminal 20 or 30, for example, being performed by the server 10. In some embodiments, the rendering of the frame image may be performed by the user terminal of the viewer, the server, the user terminal of the livestreamer or the like.

Furthermore, the system and method described in the above embodiments may be provided with a computer-readable non-transitory storage device such as a solid-state memory device, an optical disk storage device, or a magnetic disk storage device, or a computer program product or the like. AIternatively, the programs may be downloaded from a server via the Internet.

AIthough technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed but includes another variation and modification that do not disobey the present disclosure, and is the scope covered by the following patent application scope.

What is claimed is:

1. A server comprising a circuitry, wherein the circuitry is configured to perform:
receiving, via a network interface, a request for leaderboard information about an event from a user terminal of a user;
identifying a specific user according to the request, wherein the request includes an access path to the leaderboard information about the event, and the access path is associated with an identifier of the specific user;
retrieving the leaderboard information corresponding to the specific user in the event, wherein the leaderboard information further includes a ranking information indicating the position of the specific user within the leaderboard; and
providing the leaderboard information to the user terminal of the user for display, wherein the ranking information dynamically adjusts the leaderboard display such that the specific user's ranking position is displayed within a predefined viewport of the leaderboard interface.

2. The server according to claim 1, wherein:
the leaderboard information includes a threshold or condition to receive a reward in the event, and the corresponding reward; and
the leaderboard information is displayed in response to the user of the user terminal entering a live streaming room or checking a leaderboard from the leaderboard information.

3. The server according to claim 1, further comprising:
providing details of the leaderboard information in response to an operation from the user terminal of the user; wherein
the details of the leaderboard information include a threshold or condition to receive a reward in the event, and the corresponding reward.

4. The server according to claim 1, further comprising:
generating safety points via machine learning models; and
displaying the safety points and the corresponding reward; wherein
the safety points are predicted points to receive a reward in the event by the end of the event according to historical or real-time event data.

5. The server according to claim 1, further comprising:
An UI object is provided with respect to the specific user in a leaderboard; and
the UI object is configured to provide the user of the user terminal with details of the leaderboard information; and
the details of the leaderboard information include a threshold or condition to receive a reward in the event, and the corresponding reward.

6. The server according to claim 1, further comprising:
receiving a first thumbnail from a first user terminal of a first user and a second thumbnail from a second user terminal of a second user in response to a request of interaction from the first user or the second user;
retrieving context data according to a setting of the interaction;
rendering the first thumbnail and/or the second thumbnail on the context data to generate a thumbnail of the interaction; and
replacing the generated thumbnail with the first thumbnail and/or the second thumbnail.

7. The server according to claim 6, further comprising:
replacing the generated thumbnail with the first and/or second thumbnail in response to the interaction being over.

8. A terminal comprising a circuitry, wherein the circuitry is configured to perform:
receiving an UI object from a live streaming room of a specific user;
displaying the UI object on a screen of the terminal;
receiving a leaderboard information corresponding to the specific user in the event; and
displaying the leaderboard information on the screen of the terminal; wherein
the UI object is an event icon, gifting object or event sticker in a live streaming room.

9. The terminal according to claim 8, wherein:
the leaderboard information includes a threshold or condition to receive a reward in the event, and the corresponding reward; and
the leaderboard information is displayed in response to the user of the user terminal entering a live streaming room or checking a leaderboard from the leaderboard information.

10. The terminal according to claim 8, further comprising:
providing details of the leaderboard information in response to an operation from the user terminal of the user; wherein
the details of the leaderboard information include a threshold or condition to receive a reward in the event, and the corresponding reward.

11. The terminal according to claim 8, wherein:
the UI object further includes the name of an event, remaining time of the event, current ranking or current points of the specific user, or the difference of the points of the specific user with the previous or the next user in the leaderboard.

12. A computer program for causing a server to realize the functions of:
receiving, via a network interface, a request for leaderboard information about an event from a user terminal of a user;
identifying a specific user according to the request, wherein the request includes an access path to the leaderboard information about the event, and the access path is associated with an identifier of the specific user;
retrieving the leaderboard information corresponding to the specific user in the event, wherein the leaderboard information further includes a ranking information indicating the position of the specific user within the leaderboard; and
providing the leaderboard information to the user terminal of the user for display, wherein the ranking information dynamically adjusts the leaderboard display such that the specific user's ranking position is displayed within a predefined viewport of the leaderboard interface.
